(19) United States
(12) Patent Application Publication
(10) Pub. No.: US 2013/0052431 A1
(43) Pub. Date: Feb. 28, 2013

(54) CURABLE COMPOSITION FOR IMPRINTS, PATTERNING METHOD AND PATTERN

(71) Applicants: Yuichiro ENOMOTO, Haibara-gun (JP); Kunihiko KODAMA, Haibara-gun (JP); Shinji TARUTANI, Haibara-gun (JP); Hirotaka KITAGAWA, Haibara-gun (JP); Tadashi OOMATSU, Haibara-gun (JP)

(72) Inventors: Yuichiro ENOMOTO, Haibara-gun (JP); Kunihiko KODAMA, Haibara-gun (JP); Shinji TARUTANI, Haibara-gun (JP); Hirotaka KITAGAWA, Haibara-gun (JP); Tadashi OOMATSU, Haibara-gun (JP)

(73) Assignee: FUJIFILM CORPORATION, Tokyo (JP)

(21) Appl. No.: 13/594,456

(22) Filed: Aug. 24, 2012

(30) Foreign Application Priority Data
Aug. 25, 2011 (JP) 2011-183954
Jul. 27, 2012 (JP) 2012-167695

(51) Int. Cl. C08L 33/10; B29C 59/02; B32B 3/10

(52) U.S. Cl. 428/195.1; 522/33; 522/39; 522/38; 522/8; 522/9; 264/496

(57) ABSTRACT

Provided is a curable composition for imprints capable of ensuring good patternability after repetitive transfer of pattern, and less causative of defects. The curable composition for imprints comprising a polymerizable compound (A), a photo-polymerization initiator (B) and a non-polymerizable compound (C); the non-polymerizable compound (C) dissolving into the curable composition for imprints in an exothermic manner.

### CROSS-REFERENCE TO RELATED APPLICATIONS

The present application claims the benefit of priority from Japanese Patent Application No. 183954/2011, filed on Aug. 25, 2011, and Japanese Patent Application No. 167695/2012 filed on Jul. 27, 2012, the contents of which are herein incorporated by reference in their entirety.

### BACKGROUND OF THE INVENTION

1. Field of the Invention

The present invention relates to a curable composition for imprints. More precisely, the invention relates to a curable composition for patterning through photoirradiation to give imprints, which is used in producing magnetic recording media such as semiconductor integrated circuits, flat screens, microelectromechanical systems (MEMS), sensor devices, optical discs, high-density memory discs, etc.; optical members such as gratings, relief holograms, etc.; optical films for production of nanodevices, optical devices, flat panel displays, etc.; polarizing elements, thin-film transistors in liquid-crystal displays, organic transistors, color filters, overcoat layers, pillar materials, rib materials for liquid-crystal alignment, microlens arrays, immunoassay chips, DNA separation chips, microreactors, nanobio devices, optical waveguides, optical filters, photonic liquid crystals, etc.

2. Description of the Related Art

Nanoimprint technology is a development advanced from embossing technology well known in the art of optical disc production, which comprises pressing a mold original with an embossed pattern formed on its surface (this is generally referred to as “mold”, “stamper” or “template”) against a resin to thereby accurately transfer the micropattern onto the resin through mechanical deformation of the resin. In this, when a mold is once prepared, then microstructures such as nanostructures can be repeatedly molded, and therefore, this is economical, and in addition, harmful wastes and discharges from this nanotechnology are reduced. Accordingly these days, this is expected to be applicable to various technical fields.

Two methods of nanoimprint technology have been proposed; one is a thermal nanoimprint method using a thermoplastic resin as the material to be worked (for example, see S. Chou, et al., Appl. Phys. Lett. Vol. 67, 3114 (1995)), and the other is a photonanoimprint method using a photocurable composition (for example, see M. Colbun, et al., Proc. SPIE, Vol. 3676, 379 (1999)). In the thermal nanoimprint method, a mold is pressed against a polymer resin heated up to a temperature not lower than the glass transition temperature thereof, then the resin is cooled and thereafter released from the mold to thereby transfer the microstructure of the mold onto the resin on a substrate. The method is applicable to various resin materials and glass materials and is expected to be applicable to various fields. For example, U.S. Pat. Nos. 5,772,905 and 5,956,216 disclose a nanoimprint method of forming nanopatterns inexpensively.

On the other hand, in the photonanoimprint method where a curable composition for photonanoimprints is photocured by photoirradiation through a transparent mold or a transparent substrate, the transferring material does not require heating in pressing it against the mold, and therefore the method enables room-temperature imprinting. Recently, new developments having the advantages of the above two as combined, have been reported, including a nanocasting method and a reversal imprint method for forming three-dimensional structures.

For the nanoimprint methods as above, proposed are applied technologies mentioned below.

In the first technology, the molded pattern itself has a function, and is applied to various elements in nanotechnology and to structural members. Its examples include various micro/nano optical elements and high-density recording media, as well as structural members in optical films, flat panel displays, etc. The second technology is for hybrid-molding of microstructures and nanostructures, or for construction of laminate structures through simple interlayer positioning, and this is applied to production of μ-TAS (micro-total analysis system) and biochips. In the third technology, the formed pattern is used as a mask and is applied to a method of processing a substrate through etching or the like. In these technologies, high-precision positioning is combined with high-density integration; and in place of conventional lithography technology, these technologies are being applied to production of high-density semiconductor integrated circuits and transistors in liquid-crystal displays, and also to magnetic processing for next-generation hard discs referred to as patterned media. Recently, the action on industrialization of the above-mentioned nanoimprint technologies and their applied technologies has become active for practical use thereof.

As one example of nanoimprint technology, hereinunder described is an application to production of high-density semiconductor integrated circuits. The recent development in micropatterning and integration scale enlargement in semiconductor integrated circuits is remarkable, and high-definition photolithography for pattern transfer for realizing the intended micropatterning is being much promoted and advanced in the art. However, for further requirement for more definite micropatterning to a higher level, it is now difficult to satisfy all the three of micropattern resolution, cost reduction and throughput increase. Regarding this, as a technology of micropatterning capable of attaining at a low cost, nanoimprint lithography (photonanoimprint method) is proposed. For example, U.S. Pat. Nos. 5,772,905 and 5,259,926 disclose a nanoimprint technology of using a silicon wafer as a stamper for transferring a microstructure of at most 25 nm. This application requires micropatternability on a level of a few tens nm and high-level etching resistance of the micropattern functioning as a mask in substrate processing.

An exemplary application of the nanoimprint technology to manufacturing of the next-generation hard disk drive (HDD) will be explained. The HDD has been increased in the capacity by surface recording density. Increase in the recording density has, however, raised a problem of so-called spread magnetic field extended from the side faces of a magnetic head. The spread magnetic field cannot be shrunk beyond a certain level even if the head is minimized, and this results in a phenomenon called “side light”. If the side light occurs in the process of recording, data may be written also into the adjacent track to thereby erase already recorded data. On the other hand, in the process of reading, also unnecessary signals may be readout from the adjacent track due to the spread magnetic field. In order to solve this nonconformity, there have been proposed techniques such as discrete track medium and bit-patterned medium, which are configured to fill up the space between the adjacent tracks with an non-magnetic material so as to physically and magnetically isolate the tracks. Nanoimprint has been proposed as a method of forming a pattern of magnetic material or non-magnetic material, in manufacturing of these media. Also in this sort of application, the curable composition is required to ensure patternability of a few tens of nanometers, and large etching resistance when it is used as a mask for processing the substrate.

Next described is an application example of nanoimprint technology to flat displays such as liquid-crystal displays (LCD) and plasma display panels (PDP).

With the recent tendency toward large-sized LCD substrates and PDP substrates for high-definition microprocessing thereon, photonanoimprint lithography has become specifically noted these days as an inexpensive lithography technology capable of being substituted for conventional photolithography for use in production of thin-film transistors (TFT) and electrode plates. Accordingly, it has become necessary to develop a photocurable resist capable of being substituted for the etching photoresist for use in conventional photolithography.

Further, for the structural members for LCD and others, application of photonanoimprint technology to transparent protective film materials described in JP-A-2005-197699 and WO2005/552, or to spacers described in WO2005/552 is being under investigation. Differing from the above-mentioned etching resist, the resist for such structural members finally remains in displays, and therefore, it may be referred to as “permanent resist” or “permanent film”.

The spacer to define the cell gap in liquid-crystal displays is also a type of the permanent film; and in conventional photolithography, a photocurable composition comprising a resin, a photopolymerizable monomer and an initiator has been generally widely used for it (for example, see JP-A-2004-240241). In general, the spacer is formed as follows: After a color filter is formed on a color filter substrate, or after a protective film for the color filter is formed, a photocurable composition is applied thereto, and a pattern having a size of from 10 μm or 20 μm or so is formed through photolithography, and this is further thermally cured through past-baking to form the intended spacer.

The nanoimprint technology is also applicable to manufacturing of an anti-reflective structure generally called “moth eye”. The anti-reflective structure having the refractive index thereof varied in the thickness-wise direction may be obtained by forming, on the surface of a transparent mold, a very large number of fine irregularities composed of a transparent material and having a pitch smaller than the wavelength of light. This sort of anti-reflective structure may theoretically be understood as a non-reflective body, since the refractive index thereof continuously varies in the thickness-wise direction, so that there is no discontinuous boundary of refractive index. In addition, the anti-reflective structure has an anti-reflective performance better than that of a multi-layered, anti-reflective film, by virtue of its small wavelength dependence of refractive index and high anti-reflective performance to obliquely incident light.

Further, nanoimprint lithography is useful also in formation of permanent films in optical members such as microelectromechanical systems (MEMS), sensor devices, gratings, relief holograms, etc.; optical films for production of nanodevices, optical devices, flat panel displays, etc.; polarizing elements, thin-film transistors in liquid-crystal displays, organic transistors, color filters, overcoat layers, pillar materials, rib materials for liquid-crystal alignment, microlens arrays, immunoassay chips, DNA separation chips, microreactors, nanobio devices, optical waveguides, optical filters, photonic liquid crystals, etc.

In application to such permanent films, the formed pattern remains in the final products, and is therefore required to have high-level properties of mainly film durability and strength, including heat resistance, light resistance, solvent resistance, scratch resistance, high-level mechanical resistance to external pressure, hardness, etc.

Almost all patterns heretofore formed in conventional photolithography can be formed in nanoimprint technology, which is therefore specifically noted as a technology capable of forming micropatterns inexpensively.

In view of making industrial use of the nanoimprint technology, not only a good patternability, but also application-specific performances as described in the above are required.

International Patent Publication WO 2005/552 and JP-A-2005-84561 disclose that photo-curable compositions which contain fluorine-containing surfactants or modified silicone oils exhibit a good patternability when applied to nanoimprints. However, even with these compositions, problems have remained in that the patternability and defect-preventive performance may degrade after repetitive pattern transfer, and in that so-called line edge roughness, known as irregularities formed on the side faces of pattern after etching, may degrade when applied to processing of substrate.

JP-A-2010-18666 describes that the line edge roughness may be improved by adding a lubricant to the curable composition for imprints.

### SUMMARY OF THE INVENTION

In the process of forming a pattern on a substrate using a curable composition by the imprint technology, it has been known, typically as described in JP-A-2010-18666, that mold releasing property may be improved by adding a lubricant to the curable composition. This is supposedly because the lubricant functions at the interface between the mold and the pattern to be formed, in the process of curing of the curable composition. However, investigations by the present inventors revealed that this sort of lubricant partially remained on the surface of the mold. It was also found that accumulation of the lubricant residue became distinctive as the pattern was repetitively formed, and was causative of partial omission of pattern due to incomplete filling of the curable composition into the site of accumulation. It is, therefore, an object of the present invention to solve the above-described problems, and to provide a curable composition for imprints capable of ensuring good patternability after repetitive transfer of pattern, and less causative of defects. Another object is to provide a method of forming a pattern using the curable composition for imprints, and a pattern obtained by the method of forming a pattern.

In these circumstances, the present inventors found out after our thorough investigations that, by using a non-polymerizable compound which is spontaneously and rapidly miscible with the curable composition for imprints upon contact therewith, a good mold releasing property may be obtained while suppressing residue of the compound on the mold. In other words, by using a non-polymerizable compound which dissolves into the curable composition for imprints in an exothermic manner, a portion of the non-polymerizable compound remained on the mold may be re-dissolved rapidly into the next feed of curable composition applied onto the mold. Accordingly, the portion of the non-polymerizable compound remained on the mold is no longer harmful, and a good patternability may be ensured even after repetitive transfer of pattern.

More specifically, the above-described problems were solved by the embodiment <1>, and preferably by the embodiments <2> to <16>, described below.

<1> A curable composition for imprints comprising a polymerizable compound (A), a photo-polymerization initiator (B) and a non-polymerizable compound (C); the non-polymerizable compound (C) dissolving into the curable composition for imprints in an exothermic manner.

<2> The curable composition for imprints of <1>, wherein the non-polymerizable compound (C) has a molecular weight of 500 or larger.

<3> The curable composition for imprints of <1> or <2>, wherein the non-polymerizable compound (C) stays in liquid at 25° C.

<4> The curable composition for imprints of any one of <1> to <3>, wherein the non-polymerizable compound (C) has a vapor pressure at 25° C. of 100 Pa or smaller.

<5> The curable composition for imprints of any one of <1> to <4>, having a viscosity at 25° C. of smaller than 20 mPa·s.

<6> The curable composition for imprints of any one of <1> to <5>, wherein the polymerizable compound (A) is a (meth)acrylate compound.

<7> The curable composition for imprints of any one of <1> to <6>, wherein the polymerizable compound (A) has an aromatic group and/or alicyclic hydrocarbon group.

<8> The curable composition for imprints of any one of <1> to <7>, wherein the polymerizable compound (A) contains a compound having a fluorine atom and/or silicon atom.

<9> The curable composition for imprints of any one of <1> to <8>, wherein two or more species of the photo-polymerization initiator (B) are used in a combined manner.

<10> A method of producing the curable composition for imprints described in any one of <1> to <9>, the curable composition for imprints comprising the polymerizable compound (A), the photo-polymerization initiator (B) and the non-polymerizable compound (C), and the non-polymerizable compound (C) dissolving into the curable composition for imprints in an exothermic manner, the method comprising stirring the curable composition for imprints.

<11> A method of forming a pattern, comprising: applying the curable composition for imprints described in any one of <1> to <9> on a base, or on a mold having a fine pattern formed thereon; and exposing the curable composition for imprints to light, while holding it between the mold and the base.

<12> The method of forming a patterning of <11>, wherein the mold is brought into contact with a fresh curable composition for imprints, while retaining thereon the non-polymerizable compound (C).

<13> The method of forming a patterning of <11> or <12>, wherein the curable composition for imprints is applied to the base or the mold by an ink jet process.

<14> A pattern obtained by the method described in any one of <11> to <13>.

<15> An electronic device containing the pattern described in <14>.

<16> A method of manufacturing an electronic device, comprising the method of forming a pattern described in any one of <11> to <13>.

By the present invention, it became possible to provide a curable composition for imprints capable of ensuring a good patternability even after repetitive transfer of pattern, and less causative of defects.

### BEST MODE FOR CARRYING OUT THE INVENTION

The contents of the invention are described in detail hereinunder. In this description, the numerical range expressed by the wording “a number to another number” means the range that falls between the former number indicating the lowermost limit of the range and the latter number indicating the uppermost limit thereof.

In this description, “(meth)acrylate” means acrylate and methacrylate; “(meth)acrylic” means acrylic and methacrylic; “(meth)acryloyl” means acryloyl and methacryloyl. In the invention, monomer is differentiated from oligomer and polymer, and the monomer indicates a compound having a weight-average molecular weight of at most 2,000.

“Imprint” referred to in the invention is meant to indicate pattern transfer in a size of from 1 nm to 10 mm and preferably meant to indicate pattern transfer in a size of from about 10 nm to 100 μm (nanoimprint).

Regarding the expression of “group (atomic group)” in this description, the expression with no indication of “substituted” or “unsubstituted” includes both “substituted group” and “unsubstituted group”. For example, “alkyl group” includes not only an alkyl group not having a substituent (unsubstituted alkyl group) but also an alkyl group having a substituent (substituted alkyl group).

The curable composition for imprints of the present invention includes a polymerizable compound (A), a photo-polymerization initiator (B) and a non-polymerizable compound (C), and the non-polymerizable compound (C) dissolves into the curable composition for imprints in an exothermic manner.

Note that “the non-polymerizable compound (C) dissolves into the curable composition for imprints in an exothermic manner” means that, assuming now that the curable composition for imprints is mixed with an equal mass of non-polymerizable compound (C) contained in the curable composition for imprints and stirred therewith at 25° C., the curable composition for imprints is elevated in temperature, preferably by 1° C. or more, and more preferably 2° C. or more. By using the exothermic compound in a form mixed with the curable composition for imprints, the residue of the non-polymerizable compound remained on the mold may rapidly be dissolved into the next feed of the curable composition, so that a good pattern may be formed even after repetitive formation of the pattern.

The temperature rise is preferably 6° C. or smaller, more preferably 5° C. or smaller, and still more preferably 4° C. or smaller. By controlling the temperature rise within 6° C., any side reaction other than the curing reaction at the interface between the curable composition and the mold may be suppressed.

The non-polymerizable compound (C) preferably dissolves into the curable composition for imprints which contains the non-polymerizable compound (C). For example, when 0.1% by mass of the non-polymerizable compound (C) was added, in the form of liquid droplet or powder, to the curable composition for imprints which is allowed to stand still at 25° C., the non-polymerizable compound (C) preferably dissolves within 600 seconds, and more preferably within 60 seconds.

The viscosity of the curable composition of the present invention at 25° C. is preferably smaller than 20 mPa·s, more preferably 3 to 20 mPa·s, still more preferably 4 to 18 mPa·s, and most preferably 5 to 15 mPa·s. By adjusting the viscosity in these ranges, the curable composition may be spread thoroughly over a finely patterned mold.

### Polymerizable Compound (A)

While species of the polymerizable compound contained in the curable composition for imprints used in the present invention is not specifically limited so long as it does not depart from the spirit of the present invention, the polymerizable compound (A) is preferably exothermic when mixed with the non-polymerizable compound (C). More specifically, when the polymerizable compound (A) is mixed with an equal mass of the non-polymerizable compound (C) at 25° C., the composition composed of the both is preferably elevated in the temperature, preferably by 1° C. or more, and more preferably by 1 to 4° C.

The polymerizable compound (A) adoptable to the present invention is exemplified by polymerizable unsaturated monomer having 1 to 6 groups containing an ethylenic unsaturated bond; epoxy compound, oxetane compound; vinyl ether compound; styrene derivative; propenyl ether or butenyl ether.

The polymerizable unsaturated monomer having 1 to 6 groups containing an ethylenic unsaturated bond (mono- to hexa-functional polymerizable unsaturated monomer) will be explained below.

The polymerizable unsaturated monomer having one ethylenic unsaturated bond-containing group (mono-functional polymerizable unsaturated monomer) includes concretely methyl(meth)acrylate, ethyl(meth)acrylate, butyl(meth)acrylate, N-vinyl pyrrolidinone, 2-acryloyloxyethyl phthalate, 2-acryloyloxy-2-hydroxyethyl phthalate, 2-acryloyloxyethyl hexahydrophthalate, 2-acryloyloxypropyl phthalate, 2-ethyl-2-butylpropanediol acrylate, 2-ethylhexyl (meth)acrylate, 2-ethylhexylcarbitol (meth)acrylate, 2-hydroxybutyl (meth)acrylate, 2-hydroxyethyl (meth)acrylate, 2-hydroxypropyl (meth)acrylate, 4-hydroxybutyl (meth)acrylate, acrylic acid dimer, benzyl (meth)acrylate, 1- or 2-naphthyl(meth)acrylate, butoxyethyl (meth)acrylate, cetyl (meth)acrylate, ethyleneoxide-modified (hereinafter this may be referred to as “EO”) cresol (meth)acrylate, dipropylene glycol (meth)acrylate, ethoxylated phenyl (meth)acrylate, isoamyl (meth)acrylate, cyclopentanyl (meth)acrylate, isobornyl (meth)acrylate, dicyclopentanyl (meth)acrylate, dicyclopentanyloxyethyl (meth)acrylate, isomyristyl (meth)acrylate, lauryl (meth)acrylate, methoxydiproylene glycol (meth)acrylate, methoxytripropylene glycol (meth)acrylate, methoxypolyethylene glycol (meth)acrylate, methoxytriethylene glycol (meth)acrylate, neopentyl glycol benzoate (meth)acrylate, nonylphenoxypolyethylene glycol (meth)acrylate, nonylphenoxypolypropylene glycol (meth)acrylate, octyl (meth)acrylate, paracumylphenoxyethylene glycol (meth)acrylate, epichlorohydrin (hereinafter referred to as “ECH”)-modified phenoxyacrylate, phenoxyethyl (meth)acrylate, phenoxydiethylene glycol (meth)acrylate, phenoxyhexaethylene glycol (meth)acrylate, phenoxytetraethylene glycol (meth)acrylate, polyethylene glycol (meth)acrylate, polyethylene glycol-polypropylene glycol (meth)acrylate, polypropylene glycol (meth)acrylate, stearyl (meth)acrylate, EO-modified succinic acid (meth)acrylate, tribromophenyl (meth)acrylate, EO-modified tribromophenyl (meth)acrylate, tridodecyl (meth)acrylate, p-isopropenylphenol, styrene, N-vinyl pyrrolidone, N-vinyl caprolactam.

Among the monofunctional polymerizable monomers having ethylenic unsaturated bond(s), monofunctional (meth)acrylate compound is preferably used in the present invention, from the viewpoint of photo-curability. The monofunctional (meth)acrylate compound may be exemplified by those previously exemplified as the monofunctional polymerizable monomers having ethylenic unsaturated bond(s).

As the other polymerizable monomer, also preferred is a poly-functional polymerizable unsaturated monomer having two ethylenic unsaturated bond-containing groups.

As the other polymerizable monomer, also preferred is a poly-functional polymerizable unsaturated monomer having two ethylenic unsaturated bond-containing groups.

Preferred examples of the di-functional polymerizable unsaturated monomer having two ethylenic unsaturated bond-containing groups for use in the invention include diethylene glycol monoethyl ether (meth)acrylate, dimethylol-dicyclopentane di(meth)acrylate, di(meth)acrylated isocyanurate, 1,3-butylene glycol di(meth)acrylate, 1,4-butanediol di(meth)acrylate, EO-modified 1,6-hexanediol di(meth)acrylate, ECH-modified 1,6-hexanediol di(meth)acrylate, allyloxy-polyethylene glycol acrylate, 1,9-nonanediol di(meth)acrylate, EO-modified bisphenol A di(meth)acrylate, PO-modified bisphenol A di(meth)acrylate, modified bisphenol A di(meth)acrylate, EO-modified bisphenol F di(meth)acrylate, ECH-modified hexahydrophthalic acid diacrylate, hydroxypivalic acid neopentyl glycol di(meth)acrylate, neopentyl glycol di(meth)acrylate, EO-modified neopentyl glycol diacrylate, propyleneoxide (hereinafter referred to as “PO”), modified neopentyl glycol diacrylate, caprolactone-modified hydroxypivalate neopentyl glycol, stearic acid-modified pentaerythritol di(meth)acrylate, ECH-modified phthalic acid di(meth)acrylate, poly(ethylene glycol-tetramethylene glycol) di(meth)acrylate, poly(propylene glycol-tetramethylene glycol) di(meth)acrylate, polyester (di)acrylate, polyethylene glycol di(meth)acrylate, polypropylene glycol di(meth)acrylate, ECH-modified propylene glycol di(meth)acrylate, silicone di(meth)acrylate, triethylene glycol di(meth)acrylate, tetraethylene glycol di(meth)acrylate, dimethyloltricyclodecane di(meth)acrylate, neopentyl glycol-modified trimethylolpropane di(meth)acrylate, tripropylene glycol di(meth)acrylate, EO-modified tripropylene glycol di (meth)acrylate, triglycerol di(meth)acrylate, dipropylene glycol di(meth)acrylate, divinylethylene-urea, divinylpropylene-urea, o-, m-, or p-Xylylene di(meth)acrylate, 1,3-adamantane diacrylate, norbornane dimethanol diacrylate, tricyclodecane dimethanol di(meth)acrylate.

Of those, especially preferred for use in the invention are difunctional (meth)acrylates such as neopentyl glycol di(meth)acrylate, 1,9-nonanediol di(meth)acrylate, tripropylene glycol di(meth)acrylate, tetraethylene glycol di(meth)acrylate, hydroxypivalate neopentyl glycol di(meth)acrylate, polyethylene glycol di(meth)acrylate, o-, m- or p-benzen di(meth)acrylate, and o-, m- or p-xylylene di(meth)acrylate.

Examples of the polyfunctional polymerizable unsaturated monomer having at least three ethylenic unsaturated bond-containing groups include ECH-modified glycerol tri(meth)acrylate, EO-modified glycerol tri(meth)acrylate, PO-modified glycerol tri(meth)acrylate, pentaerythritol triacrylate, EO-modified phosphoric acid triacrylate, trimethylolpropane tri(meth)acrylate, caprolactone-modified trimethylolpropane tri(meth)acrylate, EO-modified trimethylolpropane tri(meth)acrylate, PO-modified trimethylolpropane tri(meth)acrylate, tris(acryloxyethyl) isocyanurate, dipentaerythritol hexa(meth)acrylate, caprolactone-modified dipentaerythritol hexa(meth)acrylate, dipentaerythritol hydroxy-penta(meth)acrylate, alkyl-modified dipentaerythritol penta(meth)acrylate, dipentaerythritol poly(meth)acrylate, alkyl-modified dipentaerythritol tri(meth)acrylate, ditrimethylolpropane tetra(meth)acrylate, pentaerythritol ethoxy-tetra(meth)acrylate, pentaerythritol tetra(meth)acrylate, etc.

Of those, especially preferred for use in the invention are tri- or more functional (meth)acrylates such as EO-modified glycerol tri(meth)acrylate, PO-modified glycerol tri(meth)acrylate, trimethylolpropane tri(meth)acrylate, EO-modified trimethylolpropane tri(meth)acrylate, PO-modified trimethylolpropane tri(meth)acrylate, dipentaerythritol hexa(meth)acrylate, pentaerythritol ethoxy-tetra(meth)acrylate, and pentaerythritol tetra(meth)acrylate.

Among the polyfunctional polymerizable unsaturated monomers having two or more ethylenically unsaturated bonds, a polyfunctional (meth)acrylate is preferably used in the invention from the viewpoint of photocurability. Furthermore, the polyfunctional (meth)acrylate as mentioned herein is the generic term referring to the difunctional (meth)acrylates and the trifunctional or higher functional (meth)acrylates. As specific examples of the polyfunctional (meth)acrylate, various polyfunctional (meth)acrylates can be used which can be selected among those exemplified as the polyfunctional polymerizable unsaturated monomers having two ethylenically unsaturated bonds and those exemplified as the polyfunctional polymerizable unsaturated monomers having three or more ethylenically unsaturated bonds.

The oxirane ring-containing compound (epoxy compound) includes, for example, polyglycidyl esters of polybasic acids, polyglycidyl ethers of polyalcohols, polyglycidyl ethers of polyoxyalkylene glycols, polyglycidyl ethers of aromatic polyols, hydrogenated polyglycidyl ethers of aromatic polyols, urethane-polyepoxy compounds, epoxidated polybutadienes, etc. One or more of these compounds may be used either singly or as combined.

Examples of the oxirane ring-containing compound (epoxy compound) preferred for use in the invention include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, hydrogenated bisphenol A diglycidyl ether, hydrogenated bisphenol F diglycidyl ether, hydrogenated bisphenol S diglycidyl ether, 1,4-butanediol diglycidyl ether, 1,6-hexanediol diglycidyl ether, glycerin triglycidyl ether, trimethylolpropane triglycidyl ether, polyethylene glycol diglycidyl ether, polypropylene glycol diglycidyl ether; polyglycidyl ethers of polyether polyols produced by adding one or more alkylene oxides to aliphatic polyalcohol such as ethylene glycol, propylene glycol, glycerin or the like; diglycidyl esters of aliphatic long-chain dibasic acids; monoglycidyl ethers of aliphatic higher alcohols; monoglycidyl ethers of polyether alcohols produced by adding alkyleneoxide to phenol, cresol, butylphenol or the like; glycidyl esters of higher fatty acids, etc.

Of those, especially preferred are bisphenol A diglycidyl ether, bisphenol F diglycidyl ether, hydrogenated bisphenol A diglycidyl ether, hydrogenated bisphenol F diglycidyl ether, 1,4-butanediol diglycidyl ether, 1,6-hexanediol diglycidyl ether, glycerin triglycidyl ether, trimethylolpropane triglycidyl ether, neopentyl glycol diglycidyl ether, polyethylene glycol diglycidyl ether, polypropylene glycol diglycidyl ether.

Commercial products favorable for use herein as the glycidyl group-containing compound are UVR-6216 (by Union Carbide), Glycidol, AOEX24, Cyclomer A200 (all by Daicel Chemical Industry), Epikote 828, Epikote 812, Epikote 1031, Epikote 872, Epikote CT508 (all by Yuka Shell), KRM-2400, KRM-2410, KRM-2408, KRM-2490, KRM-2720, KRM-2750 (all by Asahi Denka Kogyo), etc. One or more of these may be used either singly or as combined.

The production method for the oxirane ring-containing compounds is not specifically defined. For example, the compounds may be produced with reference to publications of Lecture of Experimental Chemistry 20, 4th Ed., Organic Synthesis II, p. 213, ff. (Maruzen, 1992); The chemistry of heterocyclic compounds—Small Ring Heterocycles, Part 3, Oxiranes (edited by Alfred Hasfner, John & Wiley and Sons, An Interscience Publication, New York, 1985); Yoshimura, Adhesive, Vol. 29, No. 12, 32, 1985; Yoshimura, Adhesive, Vol. 30, No. 5, 42, 1986; Yoshimura, Adhesive, Vol. 30, No. 7, 42, 1986; JP-A-11-100378, Japanese Patents 2906245 and 2926262.

As the polymerizable compound for use in the invention, vinyl ether compounds may be used.

Any known vinyl ether compounds are usable, including, for example, 2-ethylhexyl vinyl ether, butanediol 1,4-divinyl ether, diethylene glycol monovinyl ether, ethylene glycol divinyl ether, triethylene glycol divinyl ether, 1,2-propanediol divinyl ether, 1,3-propanediol divinyl ether, 1,3-butanediol divinyl ether, 1,4-butanediol divinyl ether, tetramethylene glycol divinyl ether, neopentyl glycol divinyl ether, trimethylolpropane trivinyl ether, trimethylolethane trivinyl ether, hexanediol divinyl ether, tetraethylene glycol divinyl ether, pentaerythritol divinyl ether, pentaerythritol trivinyl ether, pentaerythritol tetravinyl ether, sorbitol tetravinyl ether, sorbitol pentavinyl ether, ethylene glycol diethylene vinyl ether, triethylene glycol diethylene vinyl ether, ethylene glycol dipropylene vinyl ether, triethylene glycol diethylene vinyl ether, trimethylolpropane triethylene vinyl ether, trimethylolpropane diethylene vinyl ether, pentaerythritol diethylene vinyl ether, pentaerythritol triethylene vinyl ether, pentaerythritol tetraethylene vinyl ether, 1,1,1-tris[4-(2-vinyloxyethoxy)phenyl]ethane, bisphenol A divinyloxyethyl ether, etc.

These vinyl ether compounds can be produced, for example, according to the method described in Stephen. C. Lapin, Polymers Paint Colour Journal, 179 (4237), 321 (1989), concretely through reaction of a polyalcohol or a polyphenol with acetylene, or through reaction of a polyalcohol or a polyphenol with a halogenoalkyl vinyl ether. One or more of these compounds may be used either singly or as combined.

As the polymerizable compound for use in the invention, styrene derivatives compounds may be used. The styrene derivatives include, for example, styrene, p-methylstyrene, p-methoxystyrene, β-methylstyrene, p-methyl-β-methylstyrene, α-methylstyrene, p-methoxy-β-methylstyrene, p-hydroxystyrene, etc.

The polymerizable compounds used in the present invention preferably have an alicyclic hydrocarbon structure or an aromatic group. By using the polymerizable compound having an alicyclic hydrocarbon structure or an aromatic group, the line edge roughness when the curable composition for imprints is used as an etching resist for processing of substrate may be improved. In particular, a distinctive effect may be obtained by using a multi-functional polymerizable compound having an alicyclic hydrocarbon structure or an aromatic group.

Preferable examples of the polymerizable compound having an alicyclic hydrocarbon structure include mono-functional (meth)acrylate having an alicyclic hydrocarbon structure, such as isoboronyl (meth)acrylate, dicyclopentanyl (meth)acrylate, dicyclopentanyl oxyethyl (meth)acrylate, dicyclopentenyl (meth)acrylate, adamantyl (meth)acrylate, tricyclodecanyl (meth)acrylate and tetracyclododecanyl (meth)acrylate; and multi-functional (meth)acrylate having an alicyclic hydrocarbon structure, such as tricyclodecane dimethanol di(meth)acrylate and 1,3-adamantanediol di(meth)acrylate.

As the polymerizable monomer compound having an aromatic structure is preferably a mono-functional (meth)acrylate compound represented by the formula (I) or a poly-functional (meth)acrylate compound represented by the formula (II) as mentioned below.

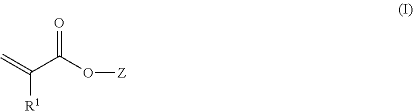

wherein Z is a group having an aromatic group; R¹ represents a hydrogen atom, an alkyl group, or a halogen atom.

R¹ is preferably a hydrogen atom, or an alkyl group, more preferably a hydrogen atom, or a methyl group, further more preferably a hydrogen atom from the viewpoint of the curability of the composition. Examples of the halogen atom include fluorine atom, chlorine atom, bromine atom, and iodine atom, and preferred is fluorine atom.

Z is an aralkyl group which may have a substituent, an aryl group which may have a substituent, or a group in which those groups are bonded to each other via a linking group. The linking group may include a hetero atom. The linking group is preferably —CH₂—, —O—, —C(═O)—, —S—, or a combination thereof. The aromatic group contained in Z is preferably a phenyl group or a naphthyl group. The molecular weight of Z is preferably 90 to 300, more preferably 120 to 250.

When the polymerizable monomer (I) is liquid at 25° C., the viscosity thereof is preferably 2 to 500 mPa·s at 25° C., more preferably 3 to 200 mPa·s, further more preferably 3 to 100 mPa·s. The polymerizable monmer (I) is preferably liquid at 25° C., or solid having a melting point of 60° C. or less, more preferably a melting point of 40° C. or less, further more preferably liquid at 25° C., or solid having a melting point of 25° C. or less.

Z preferably represents —Z¹-Z². Z¹ is a single bond, or a hydrocarbon group which may have a linking group containing a hetero atom in the chain thereof. Z² is an aromatic group which may have a substituent. Z² has a molecular weight of 90 or more.

Z¹ is more preferably an alkylene group not having a linking group containing a hetero atom in the chain thereof, more preferably a methylene group, or an ethylene group. Examples of the linking group containing a hetero atom include —O—, —C(═O)—S—, and a combination of an alkylene group and at least one of —O—, —C(═O)— and —S—. The number of the carbon atoms of Z¹ is preferably 1 to 3.

Z² is also preferably a group in which two or more aromatic groups directly bond to each other, or a group in which two or more aromatic groups bond to each other via a linking group. The linking group is preferably —CH₂—, —O—, —C(═O)—S—, or a combination thereof.

Examples of a substituent which the aromatic group may have include a halogen atom (fluorine atom, chlorine atom, bromo atom, iodine atom), a linear, a branched, or a cyclic alkyl group, an alkenyl group, an alkynyl group, an aryl group, an acyl group, an alkoxycarbonyl group, an aryloxycarbonyl group, a carbamoyl group, a cyano group, a carboxyl group, a hydroxy group, an alkoxy group, an aryloxy group, an alkylthio group, an arylthio group, a heterocyclic-oxy group, an acyloxy group, an amino group, a nitro group, a hydrazino group, a heterocyclic group. A group which is substituted with those groups is also preferred.

The amount of the compound represented by the formula (I) to be added in the composition is preferably 10 to 100% by mass, more preferably 20 to 100% by mass, further more preferably 30 to 80% by mass.

Of the compounds represented by the formula (I), specific examples of the compounds not having a substituent on the aromatic ring include benzyl (meth)acrylate, phenethyl (meth)acrylate, phenoxyethyl (meth)acrylate, 1- or 2-naphtyl (meth)acrylate, 1- or 2-naphtylmethyl (meth)acrylate, and 1- or 2-naphthylethyl (meth)acrylate.

Another preferable compound represented by the formula (I) is a compound having substituents on the aromatic ring thereof represented by the formula (I-1) below:

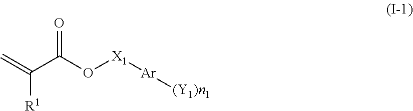

(In the formula (I-1), R¹ represents a hydrogen atom, alkyl group or halogen atom, X¹ represents a single bond or hydrocarbon group, and the hydrocarbon group may contain, in the chain thereof, a linking group having a hetero atom. Y¹ represents a substituent having a formula weight of 15 or larger, and n1 denotes an integer of 1 to 3. Ar represents an aromatic linking group, and is preferably a phenylene group or naphthylene group.)

R¹ is synonymous to R¹ in the formula in the above, specified by the same preferable ranges.

X¹ is synonymous to Z¹ in the above, specified by the same preferable ranges.

Y¹ is a substituent having a formula weight of 15 or larger, and is exemplified by alkyl group, alkoxy group, aryloxy group, aralkyl group, acyl group, alkoxycarbonyl group, alkylthio group, arylthio group, halogen atom, and cyano group. These substituents may have additional substituent(s).

When n1 is 2, X¹ is preferably a single bond or C₁ hydrocarbon group.

In a particularly preferable example, n1 is 1, and X¹ represents a C₁₋₃ alkylene group.

The compound represented by the formula (I-2) is more preferably a compound represented by either one of the formulae (I-2) and (1-3).

### Compound Represented by Formula (I-2)

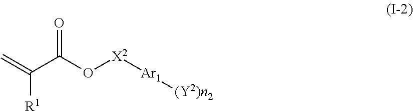

In the formula (I-2), R¹ represents a hydrogen atom, alkyl group or halogen atom. X² represents a single bond or hydrocarbon group, and the hydrocarbon group may contain, in the chain thereof, a linking group having therein a hetero atom. Y² represents a substituent having no aromatic group and having a formula weight of 15 or larger, and n2 denotes an integer of 1 to 3.

R¹ is synonymous to R¹ in the formula in the above, specified by the same preferable ranges.

When X² represents a hydrocarbon group, the hydrocarbon group is preferably C₁₋₃, preferably a substituted or unsubstituted C₁₋₃ alkylene group, more preferably an unsubstituted C₁₋₃ alkylene group, and still more preferably a methylene group or ethylene group. By adopting such hydrocarbon group, the photo-curable composition will have lower viscosity and lower volatility.

Y² represents a substituent having no aromatic group and having a formula weight of 15 or larger, the upper limit of which being preferably 150 or smaller. Preferable examples of Y² include C₁₋₆ alkyl groups such as methyl group, ethyl group, isopropyl group, Cert-butyl group and cyclohexyl group; halogen atoms such as fluoro group, chloro group, and bromo group; C₁₋₆ alkoxy groups such as methoxy group, ethoxy group, and cyclohexyloxy group; and cyano group.

n2 preferably denotes an integer of 1 or 2. When n2 is 1, the substituent Y is preferably at the para position. From the viewpoint of viscosity, when n2 is 2, X² preferably represents a single bond or C₁ hydrocarbon group.

In view of concomitantly achieving low viscosity and low volatility, the (meth)acrylate compound represented by the formula (I-2) preferably has a molecular weight of 175 to 250, and more preferably 185 to 245.

The (meth)acrylate compound represented by the formula (I-2) preferably has a viscosity at 25° C. of 50 mPa·s or smaller, and more preferably 20 mPa·s or smaller.

The compound represented by the formula (I-2) is also preferably used as a reactive diluent.

Amount of addition of the compound represented by the formula (I-2) in the photo-curable composition is preferably 10% by mass or more, from the viewpoint of viscosity of the composition or pattern accuracy after being cured, more preferably 15% by mass or more, and particularly preferably 20% by mass or more. On the other hand, from the viewpoint of tackiness or mechanical strength after being cured, the amount of addition is preferably 95% by mass or less, more preferably 90% by mass or less, and particularly preferably 85% by mass or less.

Examples of the compound represented by the formula (I-2) will be shown below, of course without limiting the present invention. R¹ represents a hydrogen atom, methyl group, or halogen atoms.

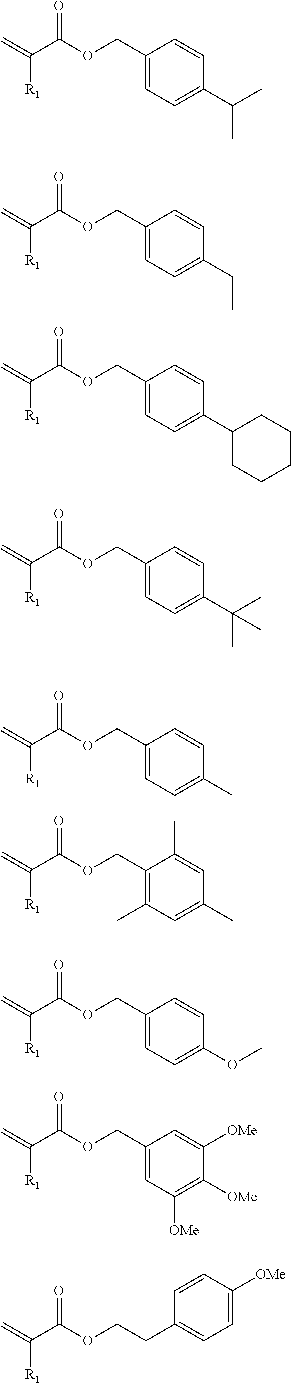

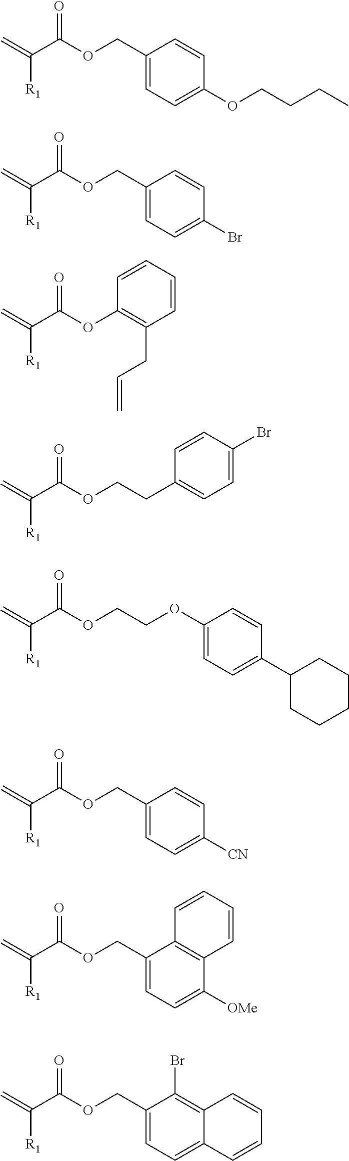

### Compound Represented by Formula (I-3)

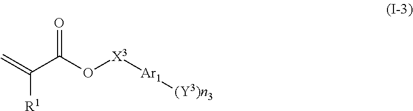

(In the formula (I-3), R¹ represents a hydrogen atom, alkyl group or halogen atom, X³ represents a single bond or hydrocarbon group, wherein the hydrocarbon group may contain, in the chain thereof, a linking group having therein a hetero atom. Y³ represents a substituent having an aromatic group, and n3 denotes an integer of 1 to 3.)

R¹ is synonymous to R¹ in the formula in the above, specified by the same preferable ranges.

Y³ represents a substituent having an aromatic group, wherein the aromatic group is preferably bonded, via a single bond or a liking group, to the aromatic group Ar in the formula (I-3). Preferable examples of the linking group include alkylene group, hetero-atom-containing linking group (preferably —O—, —S—, —C(═O)O—,), and combinations of them, wherein alkylene group, —O—, or any groups composed of combinations of them are more preferable. The substituent having an aromatic group preferably has a phenyl group together with a single bond or the above-described linking group, wherein particularly preferable examples include phenyl group, benzyl group, phenoxy group, benzyloxy group, and phenylthio group. Y³ preferably has a formula weight of 230 to 350.

n3 is preferably 1 or 2, and more preferably 1.

Amount of addition of the compound represented by the formula (I-3) in the photo-curable composition of the present invention is preferably 10% by mass or more, more preferably 20% by mass or more, and particularly preferably 30% by mass or more. On the other hand, from the viewpoint of tackiness and mechanical strength after being cured, the amount of addition is preferably 90% by mass or less, more preferably 80% by mass or less, and particularly preferably 70% by mass or less.

Examples of the compound represented by the formula (I-3) will be shown below, of course without limiting the present invention. R¹ represents a hydrogen atom, methyl group, or halogen atoms.

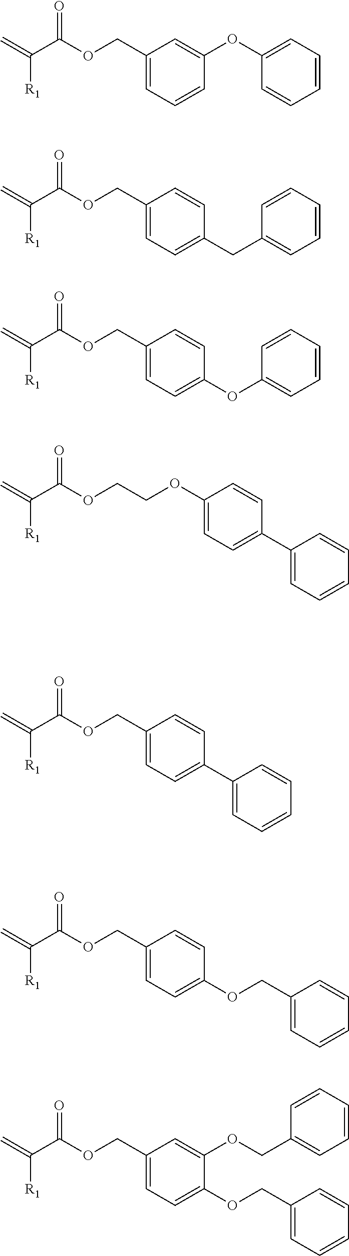

### Multi-Functional (Meth)acrylate Compound Represented by Formula (II)

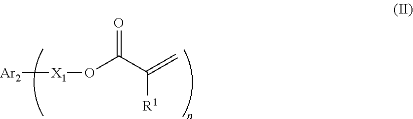

In the formula, Ar₂ represents an n-valent linking group having an aromatic group, and preferably a linking group having a phenylene group. X₁ and R¹ are synonymous to those described in the above. n is 1 to 3, and preferably 1.

The compound represented by the formula (II) is preferably the compounds represented by the formula (II-1) or (II-2) below.

### Compound Represented by Formula (II-1)

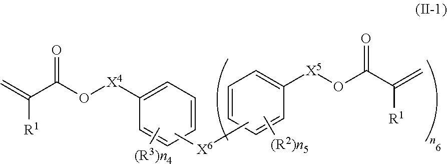

(In the formula (II-1), X⁶ represents a (n6+1)-valent linking group, and each R¹ independently represents a hydrogen atom, alkyl group, or halogen atom. Each of R² and R³ independently represents a substituent, and each of n4 and n5 independently represents an integer of 0 to 4. n6 is 1 or 2, each of X⁴ and X⁵ independently represents a hydrocarbon group, and the hydrocarbon group may contain, in the chain thereof, a hetero-atom-containing linking group.)

X⁶ represents a single bond or (n6+1)-valent linking group, and preferably represents an alkylene group, —O—, —S—, —C(═O)O—, or linking group composed of an arbitrary combination of them. The alkylene group is preferably a C₁₋₈ alkylene group, more preferably a C₁₋₃ alkylene group, and is preferably unsubstituted.

n6 is preferably 1. When n6 is 2, each of a plurality of (R¹)s, (X⁵)s and (R²) s may be same or different from each other.

Each of X⁴ and X⁵ independently represents an alkylene group having no linking group, preferably a C₁₋₅ alkylene group, more preferably a C₁₋₃ alkylene group, and most preferably a methylene group.

R¹ is synonymous to R¹ in the formula in the above, specified by the same preferable ranges.

Each of R² and R³ independently represents a substituent, and is preferably an alkyl group, halogen atom, alkoxy group, acyl group, acyloxy group, alkoxycarbonyl group, cyano group, or nitro group. The alkyl group is preferably a C₁₋₈ alkyl group. The halogen atom is exemplified by fluorine atom, chlorine atom, bromine atom, and iodine atom, wherein fluorine atom is preferable. The alkoxy group is preferably a C₁₋₈ alkoxy group.

The acyl group is preferably a C₁₋₈ acyl group. The acyloxy group is preferably a C₁₋₈ acyloxy group. The alkoxycarbonyl group is preferably a C₁₋₈ alkoxycarbonyl group.

Each of n4 and n5 independently represents an integer of 0 to 4. When n4 or n5 is 2 or larger, each of a plurality of (R²)s and (R³)s may be same or different from each other.

The compound represented by the formula (II-1) is preferably a compound represented by the formula (II-1a) below:

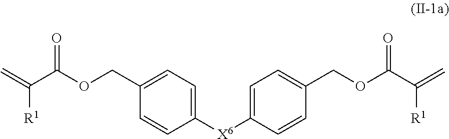

(X⁶ represents an alkylene group, —O—, —S— or a linking group composed of an arbitrary combination of them, and each R¹ independently represents a hydrogen atom, alkyl group or halogen atom.)

R¹ is synonymous to R¹ in the formula in the above, specified by the same preferable ranges.

When X⁶ represents an alkylene group, it is preferably a C₁₋₈ alkylene group, more preferably a C₁₋₃ alkylene group, and is preferably unsubstituted.

X⁶ is preferably —CH₂—, —CH₂CH₂—, —O— or —S—.

While content of the compound represented by the formula (II-1) in the photo-curable composition of the present invention is not specifically limited, from the viewpoint of viscosity of the curable composition, it is preferably 1 to 100% by mass of the total mass of polymerizable compound, more preferably 5 to 70% by mass, and particularly preferably 10 to 50% by mass.

Examples of the compounds represented by the formula (II-1) will be shown below, of course without limiting the present invention. R¹ is synonymous to R¹ in the formula (II-1), specified by the same preferable ranges, and is particularly preferably a hydrogen atom.

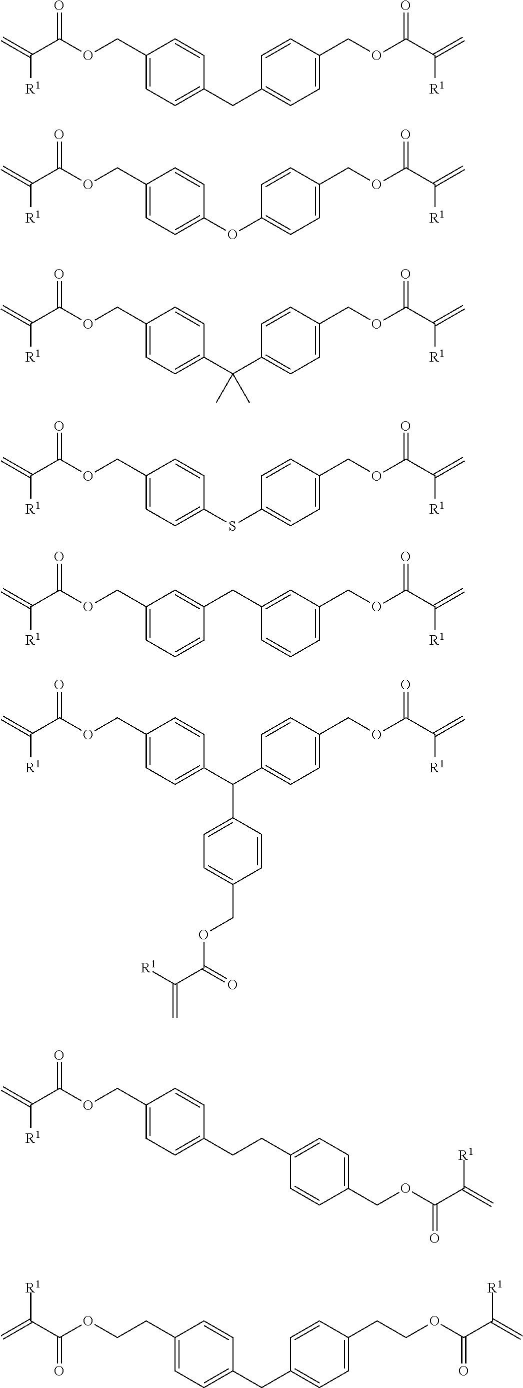

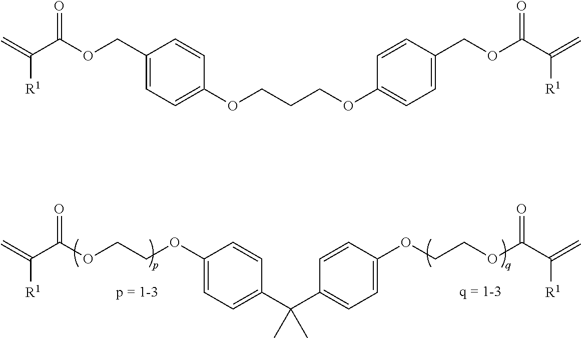

### Polymerizable Compound Represented by Formula (II-2) Below

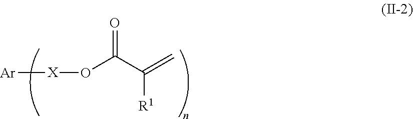

(In the formula, Ar represents an arylene group which may have a substituent, X represents a single bond or organic linking group, R¹ represents a hydrogen atom or methyl group, and n is 2 or 3.)

Examples of the arylene group in the formula includes hydrocarbon-based arylene group such as phenylene group and naphthylene group; and heteroarylene group having indole, carbazole or the like as a linking group, wherein the hydrocarbon-based arylene group is preferable, and phenylene group is more preferable from the viewpoints of less viscosity and etching resistance. The arylene group may have a substituent, wherein preferable examples of the substituent include alkyl group, alkoxy group, hydroxy group, cyano group, alkoxycarbonyl group, amide group, and sulfonamide group.

Examples of the organic linking group represented by X include alkylene group, arylene group, and aralkylene group which may contain a hetero atom in the chain thereof. Among them, alkylene group and oxyalkylene group are preferable, and alkylene group is more preferable. X is particularly preferably a single bond or alkylene group.

R¹ represents a hydrogen atom or methyl group, and is preferably a hydrogen atom.

n is 2 or 3, and preferably 2.

The polymerizable compound (1I-2) is preferably a polymerizable compound represented by the formula (II-2a) or (II-2b) below, in view of lowering the viscosity of the composition.

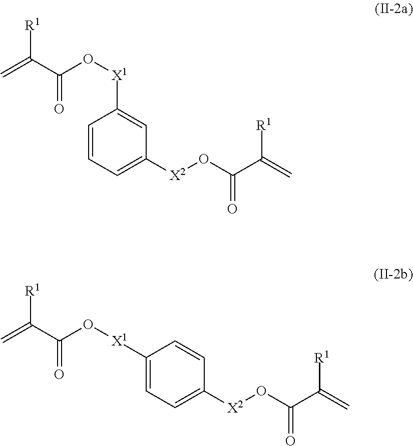

(In the formula, each of X¹ and X² independently represents single bond or an alkylene group which may have a C₁₋₃ substituent, and R¹ represents a hydrogen atom or methyl group.)

In the formula (II-2a), X¹ is preferably a single bond or methylene group, and more preferably a methylene group in view of lowering the viscosity of the composition.

Preferable ranges of X² are similar to those of X¹.

R¹ is synonymous to R¹ in the formula, specified by the same preferable ranges.

The polymerizable compound preferably exists in liquid form at 25° C., in view of suppressing deposition of some insoluble matter when the amount of addition thereof increases.

Specific examples of the polymerizable compound represented by the formula (II-2) will be shown below. R¹ is synonymous to R¹ in the formula, and represents a hydrogen atom or methyl group. Note that the present invention is not limited to these specific examples.

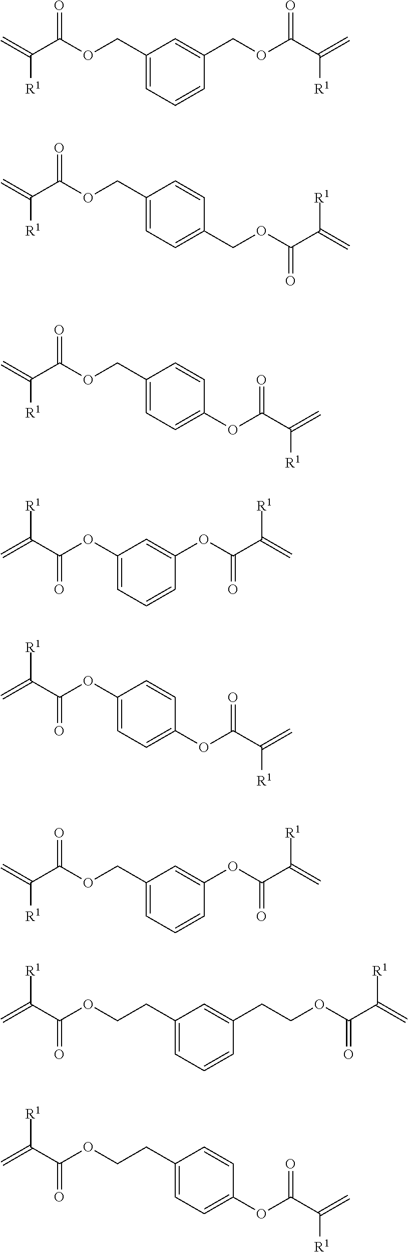

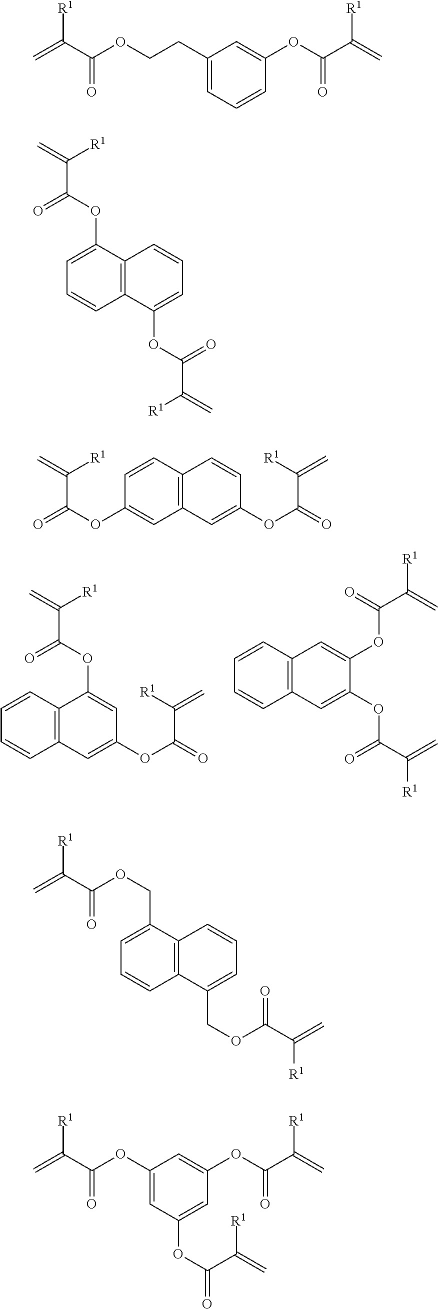

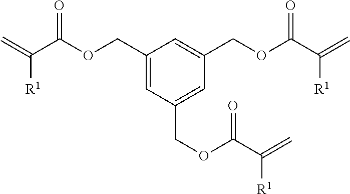

More preferable examples of the polymerizable compound having an aromatic group, used for the photo-curable composition of the present invention, will be enumerated below, without limiting the present invention.

Preferable examples of the polymerizable compound having an aromatic group include benzyl (meth)acrylate which is unsubstituted or has a substituent on the aromatic ring thereof, phenethyl (meth)acrylate which is unsubstituted or has a substituent on the aromatic ring thereof, phenoxyethyl (meth)acrylate which is unsubstituted or has a substituent on the aromatic ring thereof, 1- or 2-naphthyl (meth)acrylate which is unsubstituted or has a substituent on the aromatic ring thereof, 1- or 2-naphthylmethyl (meth)acrylate which is unsubstituted or has a substituent on the aromatic ring thereof, 1- or 2-naphthylethyl (meth)acrylate which is unsubstituted or has a substituent on the aromatic ring thereof, 1- or 2-naphthoxyethyl (meth)acrylate, resolcinol di(meth)acrylate, m-xylylene di(meth)acrylate, naphthalene di(meth)acrylate, and ethoxylated bisphenol A diacrylate. More preferable examples include benzyl acrylate which is unsubstituted or has a substituent on the aromatic ring thereof, 1- or 2-naphthylmethyl acrylate, and m-xylylene diacrylate.

(A′-1) Polymerizable Compound Having at Least Either One of Fluorine Atom and Silicon Atom

The composition of the present invention preferably contains a polymerizable compound having at least either one of fluorine atom and silicon atom. Examples of these compounds will be enumerated below.

(A′-1) Polymerizable Compound Having at Least One of Fluorine Atom and Silicon Atom, for Improved Mold Releasing Property

In the present invention, for the purpose of improving mold releasing property, a polymerizable compound having at least either one of fluorine atom and silicon atom may be added. By adding such compound, a good mold releasing property may be obtained without using surfactant.

The (A′) polymerizable compound having at least either one of fluorine atom and silicon atom of the present invention is a compound having at least one group having a fluorine atom, silicon atom, or, both of fluorine atom and silicon atom, and at least one polymerizable functional group. The polymerizable functional group is preferably a methacryloyl group, epoxy group, or vinyl ether group.

The (A′) polymerizable compound having at least either one of fluorine atom and silicon atom may be a low-molecular-weight compound or polymer.

When the (A′) polymerizable compound having at least either one of fluorine atom and silicon atom is a polymer, it may have a repeating unit having at least either one of fluorine atom and silicon atom, and a repeating unit, as a copolymerizing component, having a polymerizable group in the side chain thereof. Alternatively, the repeating unit having at least either one of fluorine atom and silicon atom may have a polymerizable group in the side chain thereof, and in particular, at the terminal thereof. In this case, while the skeleton of the repeating unit having at least either one of fluorine atom and silicon atom is not specifically limited without departing from the gist of the present invention, the repeating unit preferably has a skeleton typically derived from an ethylenic unsaturated group-containing group, and more preferably has a (meth)acrylate skeleton. The repeating unit having a silicon atom may have the silicon atom in the skeleton thereof, such as in a siloxane structure (dimethylsiloxane structure, for example). The weight average molecular weight is preferably 2,000 to 100,000, more preferably 3000 to 70,000, and particularly preferably 5,000 to 40,000.

### Polymerizable Compound Having Fluorine Atom

The fluorine atom-containing group owned by the fluorine atom-containing polymerizable compound is preferably selected from fluoroalkyl group and fluoroalkyl ether group. The fluoroalkyl group is preferably a fluoroalkyl group having carbon atoms of 2 to 20, and a fluoroalkyl group having carbon atoms of 4 to 8. Preferable examples of fluoroalkyl group include trifluoromethyl group, pentafluoroethyl group, heptafluoropropyl group, hexafluoroisopropyl group, nonafluorobutyl group, tridecafluorohexyl group, and heptadecafluorooctyl group.

The polymerizable compound having fluorine atom (A′) is preferably a polymerizable compound having trifluoromethyl group. By virtue of the trifluoromethyl group structure, the effects of the present invention may be expressed only with a small amount of addition (10% by mass or less, for example), so that compatibility with other components may be improved, line edge roughness after dry etching may be improved, and formability of repetitive pattern may be improved.

The fluoroalkyl ether group preferably has a trifluoromethyl group, similarly to the fluoroalkyl group, which may be exemplified by perfluoroethylenoxy group and perfluoropropyleneoxy group. Preferable examples are those having a fluoroalkyl ether unit having a trifluoromethyl group such as —(CF (CF₃)CF₂O)—, and/or those having a trifluoromethyl group at the terminal of the fluoroalkyl ether group.

The total number of fluorine atoms per one molecule, owned by the polymerizable compound, having at least either one of fluorine atom and silicon atom (A′), is preferably 6 to 60, more preferably 9 to 40, even more preferably 12 to 40, still more preferably 12 to 20.

The polymerizable compound having at least either one of fluorine atom has a fluorine content, defined below, of 20 to 60%, more preferably 30 to 60%, and still more preferably 35 to 60%. By adjusting the fluorine content in the appropriate range, the curable composition may be improved in compatibility with other components, less causative of fouling on mold, improved in the line edge roughness after dry etching, and improved in the formability of repetitive pattern transfer. In this patent specification, the fluorine content is given by the equation below:

Fluorine content=[{(Number of fluorine atoms in polymerizable compound)×(atomic weight of fluorine atom)}/(molecular weight of polymerizable compound)]×100

As a preferable example of the fluorine atom-containing of polymerizable compound, having at least either one of fluorine atom and silicon atom, a compound having a partial structure represented by formula (I) below may be exemplified. By adopting a compound having such partial structure, the curable composition having an excellent formability of pattern, even after repetitive pattern transfer, may be obtained, and stability over time of the composition may be improved.

—CH₂CH₂—CₙF₂ₙ₊₁ Formula (I)

In formula (I), n represents an integer of 1 to 8, and preferably 4 to 6.

One preferable example of the (A′) polymerizable compound having fluorine atom is exemplified by a compound having a partial structure represented by the following formula (II). Of course, the polymerizable compound having fluorine atom may have both of the partial structure represented by the following formula (I) and the partial structure represented by the following formula (II).

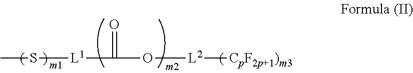

(In the formula (II), L¹ represents a single bond, or an alkylene group having carbon atoms of 1 to 8, L² represents an alkylene group having carbon atoms of 1 to 8, m1 and m2 each represent 0 or 1, wherein at least one of m1 and m2 is 1, m2 is an integer of 1 to 3, p is an integer of 1 to 8, and when m3 is 2 or more, each of —CₚF₂ₚ₊₁ may be the same or different to each other.)

The above L¹ and L² each preferably are an alkylene group having carbon atoms of 1 to 4. The alkylene group may have a substituent without diverting the scope of the gist of the present invention. The above m3 is preferably 1 or 2. The above p is preferably an integer of 4 to 6.

Examples of the fluorine atom-containing polymerizable compound will be shown below, of course without limiting the present invention.

As the fluorine atom-containing polymerizable compound, exemplified are fluorine atom-containing monofunctional polymerizable compound such as trifluoroethyl (meth)acrylate, pentafluoroethyl (meth)acrylate, (perfluorobutyl)ethyl (meth)acrylate, perfluorobutyl-hydroxypropyl (meth)acrylate, (perfluorohexyl)ethyl (meth)acrylate, octafluoropentyl (meth)acrylate, perfluorooctylethyl (meth)acrylate, tetrafluoropropyl (meth)acrylate, and hexafluoropropyl (meth)acrylate. Also multi-functional polymerizable compound having two or more polymerizable functional groups, such as those having di(meth)acrylate structure having fluoroalkylene group, exemplified by 2,2,3,3,4,4-hexafluoropentane di(meth)acrylate and 2,2,3,3,4,4,5,5-octafluorohexane di(meth)acrylate, may be preferable examples of the fluorine atom-containing polymerizable compound.

Also compounds having two or more fluorine-containing groups, such as fluoroalkyl group and fluoroalkyl ether group, in one molecule may preferably be used.

The compound having two of fluoroalkyl groups and/or fluoroalkyl ether groups in one molecule is preferably represented by the following formula (III);

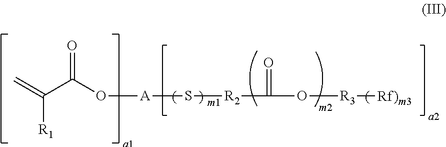

wherein R¹ represents a hydrogen atom, an alkyl group, a halogen atom, or a cyano group, preferably a hydrogen atom, or an alkyl group, more preferably a hydrogen atom, or methyl group; A is a (a1+a2)-valent linking group, preferably a linking group having an alkylene group and/or an arylene group, which may have a linking group comprising a hetero atom. Examples of the linking group having a hetero atom include —O—, —C(═O)O—, —S—, —C(═O)—, —NH—. Those groups may have a substituent, but preferably a group not having a substituent. A preferably has 2 to 50 carbon atoms, more preferably represents 4 to 15.

a1 represents an integer of 1 to 6, preferably 1 to 3, and more preferably 1 or 2.

a2 represents an integer of 2 to 6, preferably 2 or 3, and more preferably 2.

R² and R³ each represent a single bond or an alkylene group having a carbon atoms of 1 to 8. m1 and m2 each represent 0 or 1. m3 represents an integer of 1 to 3.

When a1 is 2, the individual (A)s may be same with, or different from each other.

When a2 is 2 or larger, each of R², R³, m1, m2, and m3 may be same with, or different from each other.

Rf represents a fluoroalkyl group or a fluoroalkyl ether group, preferably a fluoroalkyl group having carbon atoms of 1 to 8, and a fluoroalkyl ether group having carbon atoms of 3 to 20.

When the polymerizable compound having fluorine atom is a polymer, a polymer comprising a repeating unit derived from the above polymerizable compound having fluorine atom is preferable.

While the content of the polymerizable monomer, having at least either one of fluorine atom and silicon atom, in the curable composition for imprints of the present invention is not specifically restricted, it is preferably 0.1 to 20% by mass of the total polymerizable monomer, preferably 0.2 to 15% by mass, more preferably 0.5 to 10% by mass, and particularly preferably 0.5 to 5% by mass, in view of improving curability and reducing the viscosity of the composition.

Specific examples of the polymerizable compound having fluorine atom used for the curable composition for imprints of the present invention will be given below, without restricting the present invention. R¹ in the formulae below represents any of hydrogen atom, alkyl group, halogen atom and cyano group.

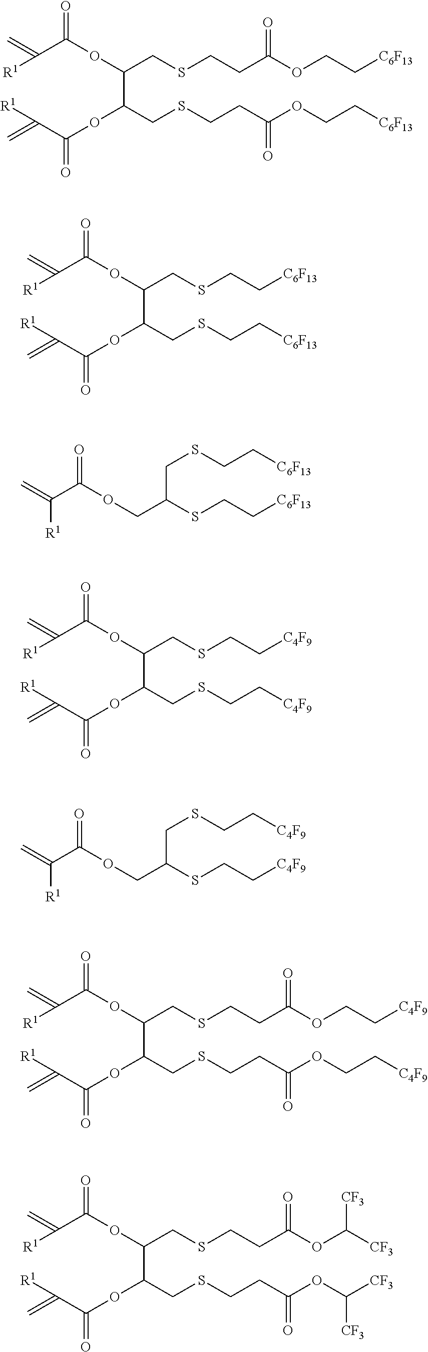

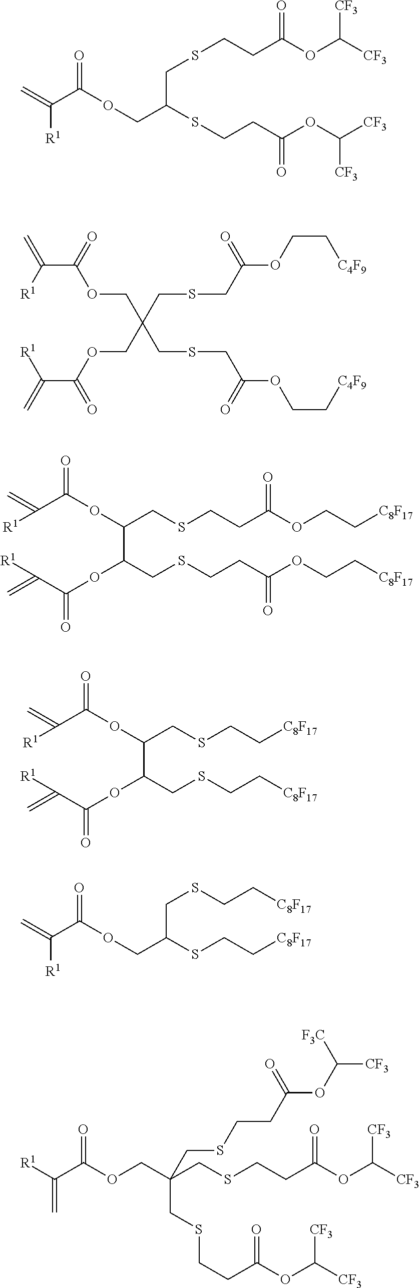

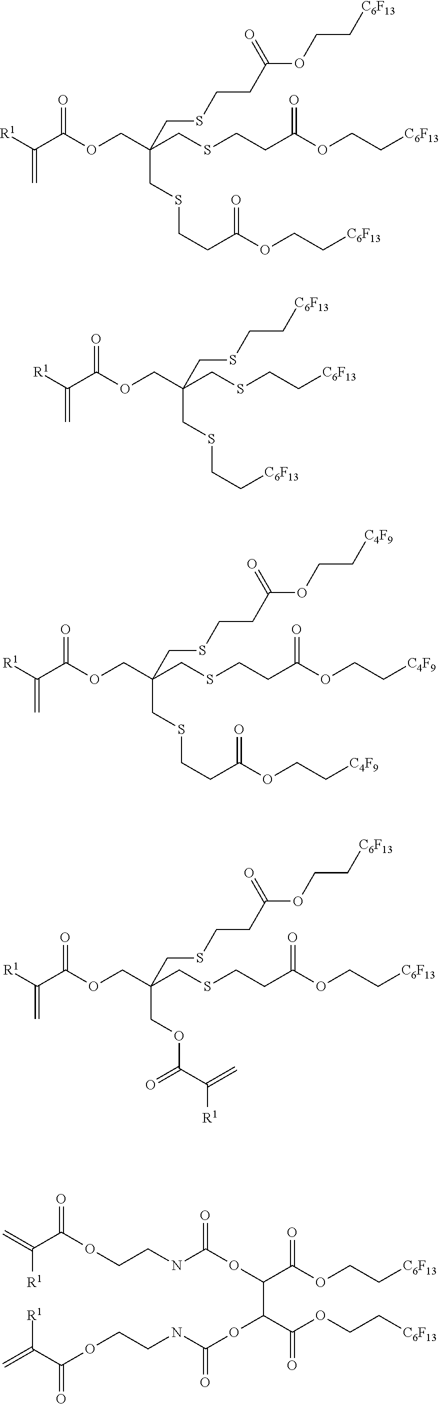

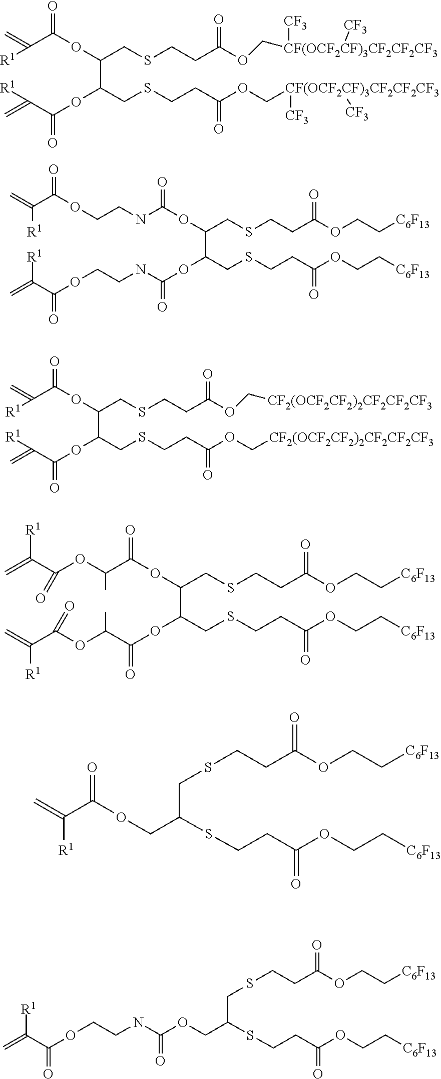

### Polymerizable Monomer Having Silicon Atom

A silicon-containing functional group that the above polymerizable monomer having silicon atom has is exemplified by a trialkyl silyl group, a trialkylsilyl group, a chain-like siloxane structure, a circular siloxane structure, and a cage-type siloxane structure. From the viewpoints of compatibility and mold releasability, it is preferable a trimethylsilyl group, or a functional group having a dimethylsiloxane structure.

The silicon atom-containing polymerizable monomer may be exemplified by 3-tris(trimethylsilyloxy)silylpropyl (meth)acrylate, trimethylsilylethyl (meth)acrylate, (meth)acryloylmethylbis (trimethylsiloxy)methyl silane, (meth)acryloxymethyl tris(trimethylsiloxy)silane, 3-(meth)acryloxypropyl bis(trimethylsiloxy)methyl silane, a polysiloxane having a (meth)acryloyl group at a terminal or at a side chain which is exemplified by X-22-164 series, X-22-174DX, X-22-2426 and X-22-2475 manufactured by Shin-Etsu Chemical Co., Ltd.

The polymerizable compound (A′) having at least either one of fluorine atom and silicon atom tends to distribute, when applied onto the base and cured, more densely towards the mold side (on the side more distant from the base). For example, a pattern obtained by using the curable composition of the present invention has a content of polymerizable compound (A′) in the 10% area thereof adjacent to the base, when viewed in the direction normal to the surface of the base, smaller than the content in the opposite 10% area adjacent to the mold. In contrast, the non-polymerizable compound (C) acts on the surface of the mold during imprinting, so as to leach out from inside of the curable composition layer. In short, the non-polymerizable compound (C) operates in a manner different from that of the polymerizable compound (A′) having at least either one of fluorine atom and silicon atom.

The polymerizable compound preferably contains a polymerizable compound having an alicyclic hydrocarbon group and/or aromatic group, and more preferably contains a polymerizable compound having an alicyclic hydrocarbon group and/or aromatic group and a polymerizable compound having a silicon atom and/or fluorine atom. The total content of the polymerizable compound having an alicyclic hydrocarbon group and/or aromatic group and the polymerizable compound having a silicon atom and/or fluorine atom, relative to the total mass of polymerizable components contained in the photo-curable composition of the present invention, is preferably 30 to 100% by mass, more preferably 70 to 100% by mass, and still more preferably 90 to 100% by mass.

In a still more preferable embodiment, the content of a (meth)acrylate polymerizable compound having an aromatic group, as the polymerizable compound, is 70 to 100% by mass of the total polymerizable components, more preferably 90 to 100% by mass, and particularly preferably 95 to 100% by mass.

In a particularly preferable embodiment, the content of the polymerizable compound (1) shown below is 0 to 80% by mass (more preferably 20 to 70% by mass) of the total polymerizable components, the content of the polymerizable compound (2) shown below is 20 to 100% by mass (more preferably 30 to 80% by mass) of the total polymerizable components, and the content of the polymerizable compound (3) shown below is 0 to 10% by mass (more preferably 0.1 to 6% by mass) of the total polymerizable components:

(1) polymerizable compound having an aromatic group (preferably phenyl group or naphthyl group, and more preferably naphthyl group), and one (meth)acrylate group;

(2) polymerizable compound having an aromatic group (preferably phenyl group or naphthyl group, and more preferably phenyl group), and two (meth)acrylate groups; and

(3) polymerizable compound having at least either one of fluorine atom and silicon atom, and a (meth)acrylate group.

In the photo-curable composition, content of a polymerizable compound having a viscosity at 25° C. of smaller than 5 mPa·s is preferably 50% by mass or less of the total polymerizable compound, more preferably 30% by mass or less, and still more preferably 10% by mass or less. By adjusting the viscosity in the above-described ranges, stability of ejection in inkjet process may be improved, and thereby defects of transfer in the imprinting process may be reduced.

### (B) Photo-Polymerization Initiator

The curable composition for imprints of the present invention contains a photo-polymerization initiator. The photo-polymerization initiator used in the present invention may be anything so far as it can generate, upon irradiation of light, an active species which promotes polymerization of the polymerizable monomer (A). The photo-polymerization initiator may be exemplified by cationic photo-polymerization initiator and radical photo-polymerization initiator, wherein the radical photo-polymerization initiator is preferable. In the present invention, a single species of the photo-polymerization initiator may be used alone, or two or more species may be used in a combined manner. More preferable embodiment uses one to three species of photo-polymerization initiator, and still more preferable embodiment uses one or two species of photo-polymerization initiator.

The content of the photo-polymerization initiator to be in all of the component except for solvents in the composition of the invention may be, for example, from 0.01 to 15% by mass of all the polymerizable monomers constituting the composition, preferably from 0.1 to 12% by mass, more preferably from 0.2 to 7% by mass. In case where two or more different types of photo-polymerization initiators are used, the total amount thereof falls within the above range.

When the content of the photo-polymerization initiator is at least 0.01% by mass, then it is favorable since the sensitivity (rapid curability), the power of resolution, the line edge accuracy and the coating film strength of the composition tend to be better. On the other hand, when the content of the photopolymerization initiator is at most 15% by mass, it is also favorable since the light transmittance, the discoloration resistance and the handlability of the composition tend to be better.

Commercially available initiators may be adoptable to the radical photo-polymerization initiator in the present invention. Those described in paragraph [0091] in Japanese-A-2008-105414 may preferably be used. Among them, acetophenone-base compound, acylphosphine oxide-base compound, and oxime ester-base compound are preferable from the viewpoint of curing sensitivity and absorption characteristics.

The acetophenone-base compound may preferably be exemplified by hydroxyacetophenone-base compound, dialkoxyacetophenone-base compound, and aminoacetophenone-base compound. The hydroxyacetophenone-base compound may preferably be exemplified by Irgacure (registered trademark) 2959 (1-[4-(2-hydroxyethoxy) phenyl]-2-hydroxy-2-methyl-1-propane-1-one, Irgacure (registered trademark) 184 (1-hydroxycyclohexylphenylketone), Irgacure (registered trademark) 500 (1-hydroxycyclohexylphenylketone, benzophenone), Darocur (registered trademark) 1173 (2-hydroxy-2-methyl-1-phenyl-1-propane-1-one), all of which are available from.

The dialkoxyacetophenone-base compound may preferably be exemplified by Irgacure (registered trademark) 651 (2,2-dimethoxy-1,2-diphenylethane-1-one) available from BASF GmbH.

The aminoacetophenone-base compound may preferably be exemplified by Irgacure (registered trademark) 369 (2-benzyl-2-dimethylamino-1-(4-morpholinophenyl) butanone-1), Irgacure (registered trademark) 379 (EG) (2-dimethylamino-2-(4-methylbenzyl)-1-(4-morpholine-4-yl-phenyl) butane-1-one), and Irgacure (registered trademark) 907 (2-methyl-1-[4-methylthiophenyl]-2-morpholinopropane-1-one), all of which are available from BASF GmbH.

The acylphosphine oxide-base compound may preferably be exemplified by Irgacure (registered trademark) 819 (bis (2,4,6-trimethylbenzoyl)-phenylphosphine oxide), Irgacure (registered trademark) 1800 (bis (2,6-dimethoxybenzoyl)-2,4,4-trimethyl-pentylphosphine oxide), Lucirin TPO (2,4,6-trimethylbenzoyldiphenylphosphine oxide), and Lucirin TPO-L (2,4,6-trimethylbenzoylphenylethoxyphosphine oxide), all of which are available from BASF GmbH.

The oxime ester-base compound may preferably be exemplified by Irgacure (registered trademark) OXE01 (1,2-octanedione,1-[4-(phenylthio) phenyl]-2-(O-benzoyloxime)), and Irgacure (registered trademark) OXE02 (ethanone,1-[9-ethyl-6-(2-methylbenzoyl)-9H-carbazole-3-yl]-1-(O-acetyloxime)), all of which are available from BASF GmbH.

The cation photo-polymerization initiator adoptable to the present invention is preferably sulfonium salt compound, iodonium salt compound, and oxime sulfonate compound, and may preferably be exemplified by 4-methylphenyl[4-(1-methylethyl) phenyliodonium tetrakis (pentafluorophenyl)borate (PI2074, from Rhodia), 4-methylphenyl [4-(2-methylpropyl)phenyliodonium hexafluorophophate (Irgacure 250), Irgacure PAG103, 108, 121 and 203 (from BASF GmbH).

It is also preferable that two or more species of photo-polymerization initiator are used in a combined manner. For the case of using two or more species together, it is more preferable to use two or more species of radical polymerization initiator. Specific examples of combination include a combination of Darocur (registered trademark) 1173 (2-hydroxy-2-methyl-1-phenyl-1-propane-1-one) and Irgacure (registered trademark) 819 (bis(2,4,6-trimethylbenzoyl)-phenylphosphine oxide); a combination of Darocur (registered trademark) 1173 (2-hydroxy-2-methyl-1-phenyl-1-propane-1-one) and Irgacure (registered trademark) 907 (2-methyl-1[4-methylthiophenyl]-2-morpholinopropane-1-one); and a combination of Darocur (registered trademark) 1173 (2-hydroxy-2-methyl-1-phenyl-1-propane-1-one) and Irgacure (registered trademark) OXE01 (1,2-octanedione, 1-[4-(phenylthio)phenyl]-2-(O-benzoyloxime). By adopting these combinations, the mold releasing property tends to further improve.

Ratio of use (ratio by mass) of the photo-polymerization initiators is preferably 9:1 to 1:9, more preferably 8:2 to 2:8, and still more preferably 7:3 to 3:7.

In the invention, “light” includes not only those having with a wavelength falling within a range of ultraviolet, near-ultraviolet, far-ultraviolet, visible, infrared, and electromagnetic waves but also radiations. The radiations include, for example, microwaves, electron beams, EUV, X-rays. In addition, laser rays such as 248 nm excimer laser, 193 nm excimer laser, 172 nm excimer laser are also usable herein. These lights may be monochromatic lights (single wavelength lights) having passed through optical filters, or may be lights of different wavelengths (composite lights). For photoexposure, multiple photoexposure may be employable, and for the purpose of enhancing the film strength and the etching resistance of the composition, entire surface photoexposure may be effected after pattern formation.

Non-Polymerizable Compound (C)

The non-polymerizable compound (C) used in the present invention is not specifically limited, so long as it dissolves into the curable composition for imprints in an exothermic manner. The non-polymerizable compound herein means a compound having no polymerizable group. It is, however, preferable that the non-polymerizable compound is not the surfactant described later.

The non-polymerizable compound (C) preferably exists in a liquid form at 25° C. By using the liquid form product, the compound (C) may rapidly be re-dissolved into the curable composition when it is brought into contact again with the curable composition. The non-polymerizable compound (C) has a vapor pressure at 25° C. of 110 Pa or below, more preferably 100 Pa or below, still more preferably 30 Pa or below, and particularly 10 Pa or below. By using such compound, an imprinting apparatus may be prevented from being contaminated.

In the present invention, the non-polymerizable compound preferably has a polyalkylene glycol structure having at least one hydroxy group at the terminal or having etherified hydroxy group, and preferably contains substantially none of fluorine atom and silicon atom.

The polyalkylene structure owned by the non-polymerizable compound (C) used in the present invention is preferably a polyalkylene glycol structure having a C₁₋₆ alkylene group, polyethylene glycol structure, polypropylene glycol structure, polybutylene glycol structure, or mixed structure of them, wherein polyethylene glycol structure, polypropylene glycol structure, or mixed structure of them is more preferable, and polypropylene glycol structure is particularly preferable.

The non-polymerizable compound is preferably configured substantially by the polyalkylene glycol structure only, except for the terminal substituent. Note that “substantially” herein means that contents of the constituents other than polyalkylene glycol structure is 5% by mass or less, and preferably 1% by mass or less, of the total. In the present invention, it is particularly preferable that a compound substantially composed of polypropylene glycol structure only is contained as the non-polymerizable compound (C).

The polyalkylene glycol structure preferably has 3 to 1000 units of alkylene glycol constitutive unit, and more preferably 4 to 500 units, still more preferably 5 to 100 units, and most preferably 5 to 50 units.

Note that “containing substantially no fluorine atom and silicon atom” typically means that the total content of the fluorine atom and silicon atom is 1% or less. It is preferable that neither fluorine atom nor silicon atom is contained. By virtue of absence of fluorine atom and silicon atom, the component (C) is improved in compatibility with the polymerizable compound, and thereby the curable composition, in particular the one containing no solvent, may be improved in uniformity of coating, patternability in imprints, and line edge roughness after dry etching.

The non-polymerizable compound (C) preferably has at least one hydroxy group at the terminal thereof, or etherified hydroxy group. Given that the non-polymerizable compound (C) has at least one hydroxy group at the terminal thereof, or given that the hydroxy group is etherified, the residual terminal may have a hydroxy group, or may have a group derived from a hydroxy group by substituting the hydrogen atom with another group. The group which may substitute a hydrogen atom of the terminal hydroxy group is preferably an alkyl group (that is, polyalkylene glycol alkyl ether), and acyl group (that is, polyalkylene glycol ester. The non-polymerizable compound (C) is more preferably polyalkylene glycol having hydroxy groups at all terminals. While a compound having a plurality of (preferably 2 or 3) polyalkylene glycol chains each bound via a linking group may preferably be used, it is more preferable to use a straight-chain having no branch in the polyalkylene glycol chain. In particular, diol-type polyalkylene glycol is preferable.

Preferable, specific examples of the non-polymerizable compound (C) include polyethylene glycol and polypropylene glycol; mono- or dimethyl ether, mono- or dioctyl ether, mono- or dinonyl ether, mono- or didecyl ether of them; and monostearate, monooleate, monoadipate and monosuccinate of them.

For the case where the polymerizable compound (C) is a polymer, the weight average molecular weight thereof is preferably 500 or larger, preferably 500 to 20000, still more preferably 500 to 5000, and furthermore preferably 500 to 2000. By selecting a molecular weight of 500 or larger, dripping of the curable composition and contamination of the imprinting apparatus are avoidable in a successful manner. On the other hand, by selecting a molecular weight of 20000 or smaller, the non-polymerizable compound (C) more readily re-dissolve into the curable composition.

Alternatively, low-volatile, low molecular weight compounds such as 1-methyl-2-pyrrolidone, dimethyl sulfoxide, and N,N-dimethylformamide, are preferably used.

Content of the non-polymerizable compound (C) is preferably 0.1 to 20% by mass of the total composition excluding the solvent, more preferably 0.2 to 10% by mass, still more preferably 0.5 to 5% by mass, and most preferably 0.5 to 3% by mass.

### (Other Ingredients)

In accordance with various objects, in addition to the above ingredient, the curable composition for imprints of the invention may contain any other ingredients such as surfactant, antioxidant and polymer without impairing the effect of the invention.

### —Surfactant—

The curable composition of the present invention may contain a surfactant. When the curable composition containing the surfactant is applied onto the base and cured, the surfactant tends to distribute, more densely towards the mold side (on the side more distant from the base). In other words, a pattern obtained by using the curable composition of the present invention has a content of polymerizable compound (A′) in the 10% area thereof adjacent to the base, when viewed in the direction normal to the surface of the base, smaller than the content in the opposite 10% area adjacent to the mold. By virtue of such maldistribution, the mold releasing property ascribable to addition of the surfactant may be expressed in an effective manner.

As the surfactant, preferred are nonionic surfactants. Preferably, the composition comprises at least one of a fluorine-containing surfactant, a silicone-type surfactant and a fluorine-containing silicone-type surfactant. More preferably, the composition comprises both a fluorine-containing surfactant and a silicone-type surfactant, or a fluorine-containing silicone-type surfactant. The most preferably, the composition comprises a fluorine-containing silicone-type surfactant. As the fluorine-containing surfactant and the silicone-type surfactant, preferred are nonionic surfactants.

“Fluorine-containing silicone-type surfactant” as referred to herein means a surfactant satisfying both the requirement of a fluorine-containing surfactant and that of a silicone-type surfactant.

Using the surfactant of the type may solve the problem of coating failures such as striation and flaky pattern formation (drying unevenness of resist film) that may occur when the composition for imprints of the invention is applied onto substrates on which various films are formed, for example, onto silicon wafers in semiconductor production, or onto glass square substrates, chromium films, molybdenum films, molybdenum alloy films, tantalum films, tantalum alloy films, silicon nitride films, amorphous silicon films, tin oxide-doped indium oxide (ITO) films or tin oxide films in production of liquid-crystal devices. In addition, the surfactant is effective for enhancing the flowability of the composition of the invention in the cavity of a female mold, for enhancing the mold-resist releasability, for enhancing the resist adhesiveness to substrates, and for lowering the viscosity of the composition. In particular, when the above-mentioned surfactant is added to the composition for imprints of the invention, the coating uniformity of the composition can be greatly improved; and in coating with it using a spin coater or a slit scan coater, the composition ensures good coating aptitude irrespective of the size of the substrate to which it is applied.

Examples of the nonionic fluorine-containing surfactant usable in the invention include Fluorad FC-430, FC-431 (Sumitomo 3M's trade names); Surflon S-382 (Asahi Glass's trade name); Eftop EF-122A, 122B, 122C EF-121, EF-126, EF-127, MF-100 (Tochem Products' trade names); PF-636, PF-6320, PF-656, PF-6520 (Omnova Solution's trade names); Futagent FT250, FT251, DFX18 (Neos' trade names); Unidyne DS-401, DS-403, DS-451 (Daikin's trade names); Megafac 171, 172, 173, 178K, 178A, F780F, 444 (DIC's trade names).

Examples of the nonionic silicone-type surfactant include SI-10 series (Takemoto Yushi's trade name), Megafac Paintad 31 DIC's trade name), KP-341 (Shin-Etsu Chemical's trade name).

Examples of the fluorine-containing silicone-type surfactant include X-70-090, X-70-091, X-70-092, X-70-093 (Shin-Etsu Chemical's trade names); Megafac R-08, XRB-4 (DIC's trade names).

In the present invention, the composition is also prepared by adding the compound having a fluorine atom and/or silicon atom as the polymerizable compound (A), substantially without using the surfactant (for example, less than 0.001% by mass of the total).

The curable composition of the present invention preferably contains the compound having fluorine atom and/or silicon atom as the polymerizable compound (A), or the surfactant having fluorine atom and/or silicon atom. The content of the surfactant used in the present invention is typically 0.001 to 5% by mass of the total composition, preferably 0.002 to 4% by mass, and still more preferably 0.005 to 3% by mass. If two or more species of surfactant are used together, the total content is adjusted to the above-described ranges. By adjusting the content of the surfactant within the range from 0.001 to 5% by mass of the total composition, uniformity in coating may be improved, and the transfer performance of the mold is less likely to degrade due to excessive surfactant.

### —Antioxidant—

Preferably, the curable composition for imprints of the invention contains a known antioxidant. The content of the antioxidant to be in the composition is, for example, from 0.01 to 10% by mass of the total amount of the polymerizable monomers constituting the composition, preferably from 0.2 to 5% by mass. When two or more different types of antioxidants are in the composition, the total amount thereof falls within the above range.

The antioxidant is for preventing fading by heat or photoirradiation, and for preventing fading by various gases such as ozone, active hydrogen NOx, SOx (x is an integer), etc. Especially in the invention, the antioxidant added to the composition brings about the advantage that the cured film is prevented from being discolored and the film thickness is prevented from being reduced through decomposition. The antioxidant includes hydrazides, hindered amine-type antioxidants, nitrogen-containing heterocyclic mercapto compounds, thioether-type antioxidants, hindered phenol-type antioxidants, ascorbic acids, zinc sulfate, thiocyanates, thiourea derivatives, saccharides, nitrites, sulfites, thiosulfates, hydroxylamine derivatives, etc. Of those, preferred are hindered phenol-type antioxidants and thioether-type antioxidants from the viewpoint of their effect of preventing cured film discoloration and preventing film thickness reduction.

Commercial products of the antioxidant usable herein include Irganox 1010, 1035, 1076, 1222 (all by BASF GmbH); Antigene P, 3C, FR, Sumilizer S, Sumilizer GA80 (by Sumitomo Chemical); Adekastab A070, A080, A0503 (by Adeka), etc. These may be used either singly or as combined.

### —Polymerization Inhibitor—

Furthermore, the curable composition for imprints of the invention preferably comprises a polymerization inhibitor. The content of the polymerization inhibitor is from 0.001 to 1% by mass, more preferably from 0.005 to 0.5% by mass, and even more preferably from 0.008 to 0.05% by mass, relative to all the polymerizable monomers, and the change in the viscosities over time can be inhibited while maintaining a high curing sensitivity by blending the polymerization inhibitor in an appropriate amount. The polymerization inhibitor may be added at the production of the polymerizable monomer or may be added the curable composition after the production of the polymerizable monomer.

The polymerization inhibitor may be exemplified by hydroquinone, p-methoxyphenol, di-tert-butyl-p-cresol, pyrogallol, tert-butylcatechol, benzoquinone, 4,4′-thiobis (3-methyl-6-tert-butylphenol), 2,2′-methylenebis (4-methyl-6-tert-butylphenol), cerium (III) salt of N-nitrosophenyl hydroxylamine, phenothiazine, phenoxazine, 4-methoxynaphthol, 2,2,6,6-tetramethylpiperidine-1-oxyl, free radical, 2,2,6,6-tetramethylpiperidine, 4-hydroxy-2,2,6,6-tetramethylpiperidine-1-oxyl, free radical, nitrobenzene, and dimethylaniline; among which preferable examples include p-benzoquinone, 2,2,6,6-tetramethylpiperidine-1-oxyl, free radical, 4-hydroxy-2,2,6,6-tetramethylpiperidine-1-oxyl, free radical, and phenothiazine.

### —Solvent—

A solvent may be used for the curable composition for imprints of the invention, in accordance with various needs. In particular, when a pattern having a thickness of at most 500 nm is formed, the composition preferably contains a solvent. Preferably, the solvent has a boiling point at normal pressure of from 80 to 200° C. Regarding the type of the solvent, any solvent capable of dissolving the composition may be used. Preferred are solvents having at least any one of an ester structure, a ketone structure, a hydroxyl group and an ether structure. Concretely, the solvent is preferably one or more selected from propylene glycol monomethyl ether acetate, cyclohexanone, 2-heptanone, gamma-butyrolactone, propylene glycol monomethyl ether, ethyl lactate. Most preferred is a solvent containing propylene glycol monomethyl ether acetate as securing coating uniformity.

The content of the solvent in the composition of the present invention may be suitably optimized depending on the viscosity of the constitutive ingredients except the solvent, the coatability of the composition and the intended thickness of the film to be formed. From the viewpoint of the coatability, the solvent content is preferably from 0 to 99% by mass of the composition. When the composition of the present invention is applied onto the substrate by inkjet method, it is preferred that the composition does not substantially contain a solvent (for example 3% by mass or less, preferably 1% by mas or less). On the other hand, when a pattern having a film thickness of 500 nm or less is formed by spin-coating method or the like, the content may be 20 to 99% by mass, preferably 40 to 99% by mass, specifically preferably 70 to 98% by mass. In the present invention, a curable composition not comprising a solvent achieves an extreme effect when the pattern is formed by inkjet.

### —Polymer Ingredient—

The composition of the invention may contain a poly-functional oligomer having a larger molecular weight than that of the above-mentioned, other poly-functional monomer within a range capable of attaining the object of the invention, for the purpose of further increasing the crosslinking density of the composition. Examples of the photoradical-polymerizable poly-functional oligomer include various acrylate oligomers such as polyester acrylates, urethane acrylates, polyether acrylates, epoxy acrylates. The amount of the oligomer ingredient to be added to the composition may be preferably from 0 to 30% by mass of the composition except the solvent therein, more preferably from 0 to 20% by mass, even more preferably from 0 to 10% by mass, most preferably from 0 to 5% by mass.

The curable composition for imprints of the present invention may further contain a polymer component, in view of improving the dry etching resistance, imprint suitability and curability. The polymer component preferably has a polymerizable functional group in the side chain thereof. Weight-average molecular weight of the polymer component is preferably 2,000 to 100,000, and more preferably 5,000 to 50,000, in view of compatibility with the polymerizable monomer. Amount of addition of the polymer component, with respect to portion of the composition excluding the solvent, is preferably 0 to 30% by mass, more preferably 0 to 20% by mass, and most preferably 2% by mass or less. Pattern formability may be improved by adjusting the content of polymer component having a molecular weight of 2,000 or larger, with respect to the portion of the curable composition for imprints of the present invention excluding the solvent. From the viewpoint of pattern formability, as least as possible amount of resin component is preferable, and therefore the curable composition preferably contains no polymer component other than those composing the surfactant or trace amounts of additives.

In addition to the above-mentioned ingredients, the curable composition for imprints of the invention may contain, if desired, UV absorbent, light stabilizer, antiaging agent, plasticizer, adhesion promoter, thermal polymerization initiator, colorant, elastomer particles, photoacid enhancer, photobase generator, basic compound, flowability promoter, defoaming agent, dispersant, etc.

The curable composition for imprints of the present invention may be prepared by mixing the individual components described in the above. Mixing and dissolution are generally proceeded in the temperature range from 10 to 40° C. Moreover, in the present invention, the curable composition prepared by mixing the individual components is preferably stirred. By the stirring, the non-polymerizable compound may readily be dissolved into the composition. Since the non-polymerizable component used in the present invention is exothermic, so that it can dissolve into the composition, even if the composition is allowed to stand still.

The curable composition prepared by mixing the individual components is preferably filtered, typically through a filter with a pore size of 0.003 μm to 5.0 μm, and more preferably 0.01 to 1.0 μm. The filtration may be proceeded in a multi-stage manner, or may be repeated a large number of times. The filtrate may be re-filtered. Material for composing a filter used for filtration may be polyethylene resin, polypropylene resin, fluorine-containing resin, nylon resin or the like, but not specifically limited.

### [Patterning Method]

The patterning method (especially micropatterning method) of using the curable composition for imprints of the invention is described below. The patterning method of the invention comprises applying the curable composition for imprints of the invention onto a substrate or a support (base) to form a patterning layer thereon; pressing a mold against the surface of the patterning layer; and irradiating the patterning layer with light, thereby curing the composition of the invention to form a micropattern.

Preferably, the curable composition for imprints of the invention is, after irradiated with light, further heated and cured. Concretely, at least the composition of the invention is applied onto a substrate (base or support) and optionally dried to form a layer comprising the composition of the invention (patterning layer), thereby preparing a pattern acceptor (having the patterning layer formed on the substrate), then a mold is pressed against the surface of the patterning layer of the pattern acceptor to thereby transfer the mold pattern onto the pattern acceptor, and the resulting micropatterned layer is cured through photoirradiation. The photoimprint lithography of the patterning method of the invention may enable lamination and multi-layer patterning, and therefore may be combined with ordinary imprint technology.

The curable composition for imprints of the invention may form a finer micropattern through photoimprint lithography, at low cost and with high accuracy. Accordingly, the composition of the invention can form micropatterns heretofore formed according to conventional lithography at low cost and with high accuracy. For example, when the composition of the invention is applied onto a substrate and the composition layer is exposed to light, cured and optionally dried (baked), then permanent films of overcoat layers or insulating films for use in liquid-crystal displays (LCD) may be formed and the formed films may be used as an etching resist in producing semiconductor integrated circuits, recording materials or flat panel displays. In particular, the patterns formed of the curable composition for imprints of the invention are excellent in etching aptitude, and can therefore be used as etching resists in dry etching with fluorocarbon, etc.

In permanent films (resists for structural members) for use in liquid-crystal displays (LCD) and in resists for use for substrate processing for electronic materials, the resist is preferably prevented from being contaminated as much as possible with metallic or organic ionic impurities in order that the resist does not interfere with the performance of the products. Accordingly, the concentration of the metallic or organic ionic impurities in the curable composition for imprints of the invention is preferably at most 1 ppm, more preferably at most 100 ppb, even more preferably at most 10 ppb.

The patterning method (pattern transferring method) with the curable composition for imprints of the invention is described concretely hereinunder.

In the patterning method of the invention, the composition of the invention is first applied (preferably coated) onto a support to form a patterning layer thereon.

As the method for providing the curable composition for imprints of the invention, a dip coating method, an air knife coating method, a curtain coating method, a wire bar coating method, a gravure coating method, an extrusion coating method, a spin coating method, a slit scanning method, an inkjet method, etc can be used to form a coated membrane or liquid particles on the substrate. The thickness of the patterning method of the composition of the invention may vary depending on the use thereof, and may be from 0.03 μm to 30 μm or so. The composition of the invention may be applied in a mode of multilayer coating. In the inkjet method and the like, the amount of a liquid particle provided on the substrate is preferably about 1 μl to about 20 μl. Between the substrate and the patterning method of the composition of the invention, any other organic layer may be formed, such as a planarizing layer, etc. With that, the patterning layer is not kept in direct contact with the substrate, and therefore, the substrate may be prevented from being contaminated with dust or from being scratched. The pattern to be formed of the composition of the invention may have good adhesiveness to the organic layer, if any, formed on the substrate.

The substrate (base or support) to which the curable composition for imprints of the invention is applied may be selected from various materials depending on its use, including, for example, quartz, glass, optical film, ceramic material, vapor deposition film, magnetic film, reflective film, metal substrate of Ni, Cu, Cr, Fe or the like, paper, SOG (spin on glass), polymer substrate such as polyester film, polycarbonate film or polyimide film, TFT array substrate, PDP electrode plate, glass or transparent plastic substrate, electroconductive substrate of ITO, metal or the like, insulating substrate, semiconductor substrate such as silicon, silicon nitride, polysilicon, silicon oxide or amorphous silicon, which, however, are not limitative. The shape of the substrate is not also specifically defined. It may be tabular or roll. As described below, the substrate may be light-transmissive or non-light-transmissive, depending on the combination thereof with a mold.

Next, in the patterning method of the invention, a mold is pressed against the surface of the patterning layer for transferring the pattern from the mold onto the patterning layer. Accordingly, the micropattern previously formed on the pressing surface of the mold is transferred onto the patterning layer.

Alternatively, the composition of the present invention may be coated over the mold having a pattern formed thereon, and the base may be pressed thereto. In the present invention, the mold may be pressed while heating the base. Temperature of heating is 25 to 30° C. or around. By the heating, the viscosity of the curable composition may be reduced, and thereby the effect of the present invention tends to be more readily expressed.

The mold material usable in the invention is described. In the photoimprint lithography with the composition of the invention, a light-transmissive material is selected for at least one of the mold material and/or the substrate. In the photoimprint lithography applied to the invention, the curable composition for imprints of the invention is applied onto a substrate to form a patterning layer thereon, and a light-transmissive mold is pressed against the surface of the layer, then this is irradiated with light from the back of the mold and the patterning layer is thereby cured. Alternatively, the curable composition for photoimprints is applied onto a light-transmissive substrate, then a mold is pressed against it, and this is irradiated with light from the back of the substrate whereby the curable composition for photoimprints can be cured.

The photoirradiation may be attained while the mold is kept in contact with the layer or after the mold is released. In the invention, preferably, the photoirradiation is attained while the mold is kept in contact with the patterning layer.

As the mold that can be used in the invention, a mold having a transferable pattern formed thereon is used. The pattern on the mold may be formed, for example, through photolithography, electronic beam lithography, or the like according to the desired processing accuracy, but in the invention, the mold patterning method is not specifically defined. Even if a pattern is transferred by using a mold having the smallest pattern size of 50 nm or less, the curable composition of the present invention can provide good patternability.

Not specifically defined, the light-transmissive mold material for use in the invention may be anyone having a desired strength and durability. Concretely, its examples include glass, quartz, light-transparent resin such as PMMA or polycarbonate resin, transparent metal deposition film, flexible film of polydimethylsiloxane or the like, photocured film, metal film, etc.

The non-light-transmissive mold to be used in the invention where a light-transmissive substrate is used is not also specifically defined and may be any one having a predetermined strength. Concretely, examples of the mold material include ceramic material, deposition film, magnetic film, reflective film, metal material of Ni, Cu, Cr, Fe or the like, as well as SiC, silicon, silicon nitride, polysilicon, silicon oxide, amorphous silicon, etc. However, these are not limitative. The shape of the mold is not also specifically defined, and may be any of a tabular mold or a roll mold. The roll mold is used especially when continuous transfer in patterning is desired.

The mold for use in the patterning method of the invention may be processed for surface release treatment for the purpose of enhancing the releasability of the curable composition for imprints of the invention from the mold. The mold of the type includes those surface-treated with a silicone-type or fluorine-containing silane coupling agent, for which, for example, commercial release agents such as Daikin's Optool DSX, Sumitomo 3M's Novec EGC-1720 and others are preferred. The curable composition of the present invention can exhibit excellent patternability even if a mold in which release treatment is not conducted is used.

In photoimprint lithography with the composition of the invention, in general, the mold pressure in the patterning method of the invention is preferably at most 10 atmospheres. When the mold pressure is at most 10 atmospheres, then the mold and the substrate are hardly deformed and the patterning accuracy tends to increase. It is also favorable since the pressure unit may be small-sized since the pressure to be given to the mold may be low. The mold pressure is preferably selected from the region capable of securing the mold transfer uniformity, within a range within which the residual film of the curable composition for imprints in the area of mold pattern projections may be reduced.

In the patterning method of the invention, the dose of photoirradiation in the step of irradiating the patterning layer with light may be sufficiently larger than the dose necessary for curing. The dose necessary for curing may be suitably determined depending on the degree of consumption of the unsaturated bonds in the curable composition for imprints and on the tackiness of the cured film as previously determined.

In the photoimprint lithography adopted to the present invention, while the substrate in the process of exposure to light is generally kept at room temperature, the substrate may alternatively be heated in order to enhance the reactivity. Prior to the exposure to light, an atmosphere is preferably evacuated to vacuum, or replaced by helium, more preferably replaced by helium. By adopting the configuration, vaporization of the low-molecular-weight component during the exposure may be prevented, and thereby changes in performances over the time the work is kept in the apparatus may be suppressed. In the method of forming a pattern of the present invention, a preferable range of the degree of vacuum during exposure is from 10⁻¹ Pa to normal pressure.

Light to be used for photoirradiation to cure the curable composition for imprints of the invention is not specifically defined. For example, it includes light and irradiations with a wavelength falling within a range of high-energy ionizing radiation, near-ultraviolet, far-ultraviolet, visible, infrared, etc. The high-energy ionizing radiation source includes, for example, accelerators such as Cockcroft accelerator, Handegraf accelerator, linear accelerator, betatoron, cyclotron, etc. The electron beams accelerated by such an accelerator are used most conveniently and most economically; but also are any other radioisotopes and other radiations from nuclear reactors, such as y rays, X rays, a rays, neutron beams, proton beams, etc. The UV sources include, for example, UV fluorescent lamp, low-pressure mercury lamp, high-pressure mercury lamp, ultra-high-pressure mercury lamp, xenon lamp, carbon arc lamp, solar lamp, etc. The radiations include microwaves, EUV, etc. In addition, laser rays for use in microprocessing of semiconductors, such as LED, semiconductor laser ray, 248 nm KrF excimer laser ray, 193 nm ArF excimer laser ray and others, are also favorably used in the invention. These lights may be monochromatic lights, or may also be lights of different wavelengths (mixed lights).

In photoexposure, the light intensity is preferably within a range of from 1 mW/cm² to 50 mW/cm². When the light intensity is at least 1 mW/cm², then the producibility may increase since the photoexposure time may be reduced; and when the light intensity is at most 50 mW/cm², then it is favorable since the properties of the permanent film formed may be prevented from being degraded owing to side reaction. Also preferably, the dose in photoexposure is within a range of from 5 mJ/cm² to 1000 mJ/cm². When the dose is less than 5 mJ/cm², then the photoexposure margin may be narrow and there may occur problems in that the photocuring may be insufficient and the unreacted matter may adhere to mold. On the other hand, when the dose is more than 1000 mJ/cm², then the composition may decompose and the permanent film formed may be degraded.

Further, in photoexposure, the oxygen concentration in the atmosphere may be controlled to be less than 100 mg/L by introducing an inert gas such as nitrogen or argon into the system for preventing the radical polymerization from being retarded by oxygen.

In the patterning method of the invention, after the pattern layer is cured through photoirradiation, if desired, the cured pattern may be further cured under heat given thereto. The method may additionally includes the post-curing step. Thermal curing of the composition of the invention after photoirradiation is preferably attained at 150 to 280° C., more preferably at 200 to 250° C. The heating time is preferably from 5 to 60 minutes, more preferably from 15 to 45 minutes.

### [Pattern]

The pattern thus formed according to the patterning method of the invention as described in the above can be used as a permanent film (resist for structural members) for use in liquid-crystal displays (LCD) and others, or as an etching resist. After its production, the composition of the invention may be bottled in a container such as a gallon bottle or a coated bottle, and may be transported or stored. In this case, the container may be purged with an inert gas such as nitrogen, argon or the like for preventing the composition therein from being degraded. The composition may be transported or stored at ordinary temperature, but for preventing the permanent film from being degraded, it is preferably transported or stored at a controlled temperature of from −20° C. to 0° C. Needless-to-say, the composition is shielded from light to such a level on which its reaction does not go on.

The pattern formed according to the patterning method of the invention is useful as an etching resist. In case where the composition for imprints of the invention is used as an etching resist, a nano-order micropattern is first formed on a substrate such as a silicon wafer with a thin film of SiO₂ or the like formed thereon, according to the patterning method of the invention. Next, this is etched with hydrogen fluoride in wet etching, or with CF₄ in dry etching, thereby forming a desired pattern on the substrate. The curable composition for imprints of the invention exhibits especially good etching resistance in dry etching.

### EXAMPLES

The characteristics of the invention are described more concretely with reference to Production Examples and Examples given below. In the following Examples, the material used, its amount and the ratio, the details of the treatment and the treatment process may be suitably modified or changed not overstepping the scope of the invention. Accordingly, the invention should not be limitatively interpreted by the Examples mentioned below.

### (Preparation of Curable Composition)

The polymerizable compound, the photo-polymerization initiator, and the non-polymerizable compound, listed in Table below, were mixed. The mixture was further added with 200 ppm (0.02% by mass), relative to the polymerizable compound, of 4-hydroxy-2,2,6,6-tetramethylpiperidine-1-oxyl, free radical (from Tokyo Chemical Industry Co. Ltd.) as a polymerization inhibitor, and stirred, to thereby prepare each composition of the present invention, or each comparative composition. Each composition was filtered through a polyethylene filter with a pore size of 0.1 μm.

### <Polymerizable Compound (A)>

A1: m-xylylene diacrylate (synthesized by a general method from α,α′-dichloro-m-xylene and acrylic acid)
A2: 2-naphthylmethyl acrylate (synthesized by a general method from 2-bromomethylnaphthalene and acrylic acid)
A3: isoboronyl acrylate (IBXA, from Osaka Organic Chemical Industry Ltd.)
A4: phenoxypolyethylene glycol acrylate (NK ester AMP-10G, from Shin-Nakamura Chemical Co. Ltd.)
A5: neopentyl glycol diacrylate (Light Acrylate NP-A, from Kyoeisha Chemical Co. Ltd.)
A′1:(perfluorohexyl)ethyl acrylate (from Kanto Chemical Co. Inc.)

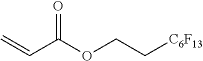

A′2: Synthesized by a method described in JP-A-2010-239121

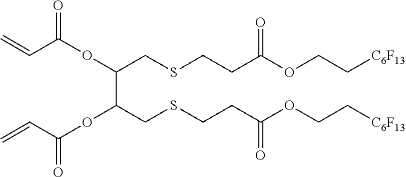

### <Photo-Polymerization Initiator (B)>

P-1: 2-hydroxy-2-methyl-1-phenyl-1-propane-1-one (Darocur 1173, from BASF GmbH)
P-2: (2-dimethylamino-2-(4-methylbenzyl)-1-(4-morpholine-4-ylphenyl)butane-1-one (Irgacure 379EG, from BASF GmbH)
P-3: 1-[4-(2-hydroxyethoxy)phenyl]-2-hydroxy-2-methyl-1-propane-1-one (Irgacure 2959, from BASF GmbH)
P-4: 1-hydroxycyclohexylphenylketone (Irgacure 184, from BASF GmbH)
P-5: 2,2-dimethoxy-1,2-diphenylethane-1-one (Irgacure 651, from BASF GmbH)
P-6: 2-benzyl-2-dimethylamino-1-(4-morpholinophenyl)butanone-1 (Irgacure 369, from BASF GmbH)
P-7: 2-methyl-1[4-methylthiophenyl]-2-morpholinopropane-1-one (Irgacure 907, from BASF GmbH)
P-8: bis(2,4,6-trimethylbenzoyl)-phenylphosphine oxide (Irgacure 819, from BASF GmbH)

### P-9:

bis(2,6-dimethoxybenzoyl)-2,4,4-trimethyl-pentylphosphine oxide (Irgacure 1800, from BASF GmbH)
P-10: 2,4,6-trimethylbenzoylphenylethoxyphosphine oxide (Lucirin TPO-L, from BASF GmbH)
P-11: 2,4,6-trimethylbenzoyldiphenylphosphine oxide (Lucirin TPO, from BASF GmbH)
P-12: 1,2-octanedione-1-[4-(phenylthio)phenyl]-2-(O-benzoyloxime) (Irgacure OXE01, from BASF GmbH

### <Non-Polymerizable Compound (C)>

C-1: polyethylene glycol monomethyl ether (from Wako Pure Chemical Industries, Ltd., Mw550, liquid at 25° C., vapor pressure at 25° C.: <10 Pa)
C-2: polypropylene glycol (from Wako Pure Chemical Industries, Ltd., diol-type, Mw700, liquid at 25° C., vapor pressure at 25° C.: <10 Pa)
C-3: polypropylene glycol (from Wako Pure Chemical Industries, Ltd., diol-type, Mw400, liquid at 25° C., vapor pressure at 25° C.: <10 Pa)
C-4: polyethylene glycol (from Wako Pure Chemical Industries, Ltd., Mw12000, solid at 25° C.)
C-5: polyhydroxystyrene (synthesized by a general method, Mw600, solid at 25° C.)
C-6: polymethyl methacrylate (from Wako Pure Chemical Industries, Ltd., Mw6000, solid at 25° C.)
C-7: 1-methyl-2-pyrrolidone (from Tokyo Chemical Industry Co. Ltd., vapor pressure at 25° C.: 70 Pa)
C-8: dimethyl sulfoxide (from Wako Pure Chemical Industries, Ltd., vapor pressure at 25° C.: 100 Pa)

### <Surfactant>

D-1: Surflon S-386 (from Asahi Glass Co. Ltd.)
D-2: PF-636 (from Omnova Solutions, Inc.)
D-3: Megafac F-444 (from DIC Corporation)

TABLE 1

| | | | Fluorine- | | | | | | | | |
|---|---|---|---|---|---|---|---|---|---|---|---|
| | | | containing | | Photo- | | | | | | |
| | | | poly- | | poly- | | | | | | |
| | | | merizable | | merization | | Non- | | | | |
| | Polymerizable | | compound | | initiator | | polymerizable | | | | |
| | compound (A) | | (A′) | | (B) | | compound (C) | | | Surfactant | |
| | Type | Content | Type | Content | Type | Content | Type | Content | Mw | Type | Content |
| Example 1 | A1 | 94 | A′1 | 2 | P-2 | 2 | C-1 | 2 | 550 | None | — |
| Example 2 | A1 | 94 | A′2 | 2 | P-2 | 2 | C-1 | 2 | 550 | None | — |
| Example 3 | A1 | 96 | None | — | P-2 | 2 | C-1 | 2 | 550 | None | — |
| Example 4 | A1 | 95 | none | — | P-2 | 2 | C-1 | 2 | 550 | D-1 | 1 |
| Example 5 | A1 | 95 | A′2 | 1 | P-1 | 2 | C-2 | 2 | 700 | None | — |
| Example 6 | A1 | 95 | None | — | P-1 | 2 | C-3 | 3 | 400 | None | — |
| Example 7 | A1/A2 = 50% by | 96 | A′1 | 1 | P-2 | 2 | C-4 | 1 | 12000 | None | — |
| | mass/50% by mass | | | | | | | | | | |
| Example 8 | A1/A2 = 50% by | 95 | A′1 | 1 | P-2 | 2 | C-1 | 2 | 550 | None | — |
| | mass/50% by mass | | | | | | | | | | |
| Example 9 | A1/A2 = 50% by | 94 | A′2 | 2 | P-2 | 2 | C-1 | 2 | 550 | None | — |
| | mass/50% by mass | | | | | | | | | | |
| Example 10 | A1/A2 = 50% by | 95 | None | — | P-1 | 2 | C-2 | 3 | 700 | None | — |
| | mass/50% by mass | | | | | | | | | | |
| Example 11 | A1/A2 = 50% by | 94 | None | — | P-1 | 2 | C-2 | 2 | 700 | D-2 | 2 |
| | mass/50% by mass | | | | | | | | | | |
| Example 12 | A3 | 94 | A′1 | 2 | P-2 | 2 | C-1 | 2 | 550 | None | — |
| Example 13 | A3 | 95 | A′1 | 2 | P-1 | 2 | C-3 | 1 | 400 | None | — |
| Example 14 | A3 | 95 | A′2 | 1 | P-2 | 2 | C-4 | 2 | 12000 | None | — |
| Example 15 | A3 | 97 | None | — | P-1 | 2 | C-1 | 1 | 550 | None | — |
| Example 16 | A3 | 96 | None | — | P-1 | 2 | C-1 | 1 | 550 | D-3 | 1 |
| Example 17 | A1 | 94 | A′1 | 2 | P-2 | 2 | C-2 | 2 | 700 | None | — |
| Example 18 | A1 | 94 | A′1 | 2 | P-2 | 2 | C-3 | 2 | 400 | None | — |
| Example 19 | A1 | 94 | A′1 | 2 | P-2 | 2 | C-4 | 2 | 12000 | None | — |
| Example 20 | A1 | 94 | A′1 | 2 | P-2 | 2 | C-7 | 2 | 99 | None | — |
| Example 21 | A1 | 94 | A′1 | 2 | P-2 | 2 | C-8 | 2 | 78 | None | — |
| Comparative | A1 | 94 | A′1 | 2 | P-2 | 2 | C-5 | 2 | 600 | None | — |
| Example 1 | | | | | | | | | | | |
| Comparative | A1 | 94 | A′1 | 2 | P-2 | 2 | C-6 | 2 | 6000 | None | — |
| Example 2 | | | | | | | | | | | |
| Comparative | A1/A2 = 50% by | 96 | A′2 | 1 | P-2 | 2 | C-6 | 1 | 6000 | None | — |
| Example 3 | mass/50% by mass | | | | | | | | | | |
| Comparative | A3 | 96 | A′1 | 2 | P-2 | 2 | [symbol] | — | — | None | — |
| Example 4 | | | | | | | | | | | |

TABLE 2

| | | | Fluorine- | | | | | | | | |
|---|---|---|---|---|---|---|---|---|---|---|---|
| | | | containing | | | | | | | | |
| | | | poly- | | | | Non- | | | | |
| | Polymerizable | | merizable | | Photo-polymerization | | polymerizable | | | | |
| | compound (A) | | compound | | initiator (B) | | compound (C) | | | Surfactant | |
| | Type | Content | Type | Content | Type | Content | Type | Content | Mw | Type | Content |
| Example 22 | A1 | 94 | A′1 | 2 | P-3 | 2 | C-1 | 2 | 550 | [symbol] | — |
| Example 23 | A1 | 94 | A′1 | 2 | P-5 | 2 | C-1 | 2 | 550 | [symbol] | — |
| Example 24 | A1 | 94 | A′1 | 2 | P-7 | 2 | C-1 | 2 | 550 | [symbol] | — |
| Example 25 | A1 | 94 | A′1 | 2 | P-9 | 2 | C-1 | 2 | 550 | [symbol] | — |
| Example 26 | A1 | 94 | A′1 | 2 | P-11 | 2 | C-1 | 2 | 550 | [symbol] | — |
| Example 27 | A1/A2 = 50% by mass/ | 93 | A′1 | 2 | P-1 | 2 | C-2 | 3 | 700 | [symbol] | — |
| | 50% by mass | | | | | | | | | | |
| Example 28 | A1/A2 = 50% by mass/ | 91 | A′1 | 2 | P-1/P-2 = 50% by | 4 | C-2 | 3 | 700 | [symbol] | — |
| | 50% by mass | | | | mass/50% by mass | | | | | | |
| Example 29 | A1/A2 = 50% by mass/ | 91 | A′1 | 2 | P-1/P-4 = 50% by | 4 | C-2 | 3 | 700 | [symbol] | — |
| | 50% by mass | | | | mass/50% by mass | | | | | | |
| Example 30 | A1/A2 = 50% by mass/ | 91 | A′1 | 2 | P-1/P-6 = 50% by | 4 | C-2 | 3 | 700 | [symbol] | — |
| | 50% by mass | | | | mass/50% by mass | | | | | | |
| Example 31 | A1/A2 = 50% by mass/ | 91 | A′1 | 2 | P-1/P-8 = 50% by | 4 | C-2 | 3 | 700 | [symbol] | — |
| | 50% by mass | | | | mass/50% by mass | | | | | | |
| Example 32 | A1/A2 = 50% by mass/ | 91 | A′1 | 2 | P-1/P-10 = 50% by | 4 | C-2 | 3 | 700 | [symbol] | — |
| | 50% by mass | | | | mass/50% by mass | | | | | | |
| Example 33 | A1/A2 = 50% by mass/ | 91 | A′1 | 2 | P-1/P-12 = 50% by | 4 | C-2 | 3 | 700 | [symbol] | — |
| | 50% by mass | | | | mass/50% by mass | | | | | | |
| Example 34 | A1/A2 = 30% by mass/ | 91 | A′1 | 2 | P-1/P-8 = 50% by | 4 | C-2 | 3 | 700 | [symbol] | — |
| | 70% by mass | | | | mass/50% by mass | | | | | | |
| Example 35 | A1/A2 = 50% by mass/ | 91 | A′1 | 2 | P-2/P-5 = 50% by | 4 | C-2 | 3 | 700 | [symbol] | — |
| | 50% by mass | | | | mass/50% by mass | | | | | | |
| Example 36 | A1/A2 = 70% by mass/ | 91 | A′1 | 2 | P-1/P-2 = 50% by | 4 | C-2 | 3 | 700 | [symbol] | — |
| | 30% by mass | | | | mass/50% by mass | | | | | | |
| Example 37 | A1/A4 = 50% by mass/ | 89 | A′1 | 2 | P-1/P-2 = 50% by | 4 | C-2 | 5 | 700 | [symbol] | — |
| | 50% by mass | | | | mass/50% by mass | | | | | | |
| Example 38 | A1/A5 = 50% by mass/ | 89 | A′1 | 2 | P-1/P-4 = 50% by | 4 | C-2 | 5 | 700 | [symbol] | — |
| | 50% by mass | | | | mass/50% by mass | | | | | | |
| Example 39 | A1/A4 = 75% by mass/ | 89 | A′1 | 2 | P-1/P-6 = 50% by | 4 | C-2 | 5 | 700 | [symbol] | — |
| | 25% by mass | | | | mass/50% by mass | | | | | | |
| Example 40 | A1/A5 = 75% by mass/ | 89 | A′1 | 2 | P-1/P-8 = 50% by | 4 | C-2 | 5 | 700 | [symbol] | — |
| | 25% by mass | | | | mass/50% by mass | | | | | | |
| Example 41 | A1/A4 = 25% by mass/ | 89 | A′1 | 2 | P-1/P-10 = 50% by | 4 | C-2 | 5 | 700 | [symbol] | — |
| | 75% by mass | | | | mass/50% by mass | | | | | | |
| Example 42 | A1/A5 = 25% by mass/ | 89 | A′1 | 2 | P-1/P-12 = 50% by | 4 | C-2 | 5 | 700 | [symbol] | — |
| | 75% by mass | | | | mass/50% by mass | | | | | | |
| Comparative | A1/A2 = 50% by mass/ | 91 | A′1 | 2 | P-1/P-6 = 50% by | 4 | C-5 | 3 | 600 | [symbol] | — |
| Example 5 | 50% by mass | | | | mass/50% by mass | | | | | | |
| Comparative | A1/A4 = 50% by mass/ | 89 | A′1 | 2 | P-1/P-2 = 50% by | 4 | C-6 | 5 | 6000 | [symbol] | — |
| Example 6 | 50% by mass | | | | mass/50% by mass | | | | | | |
| Comparative | A1/A5 = 50% by mass/ | 94 | A′1 | 2 | P-1/P-4 = 50% by | 4 | [symbol] | — | — | [symbol] | — |
| Example 7 | 50% by mass | | | | mass/50% by mass | | | | | | |

### <Measurement of Viscosity of Curable Composition>

The viscosity of the compositions (before cured) were measured using a rotary viscometer Model RE-80L from Toki Sangyo Co. Ltd., at 25±0.2° C.

The rotational speed during the measurement was set to 20 rpm.

### <Temperature Rise of Curable Composition>

Temperature rise of the curable compositions obtained by mixing the curable compositions in Examples and Comparative Examples with the equal mass of the non-polymerizable compound (C) was measured. Temperature fall was denoted by sign “−”. The samples were evaluated at a room temperature of 25° C.

### <Rectangularity in Initial Patterning>

A mold used herein was a quartz mold having a rectangular line/space pattern with a line width of 30 nm, a trench depth of 60 nm, and a line edge roughness of 3.0 nm.

An ink jet apparatus used herein was an ink jet printer DMP-2831 from FUJIFILM Dimatix, Inc., by which each curable composition was discharged onto a silicon wafer at a volume of droplet of 1 μl per nozzle, so as to form a square dot matrix of 100 μm pitch. The temperature of the discharged curable composition was adjusted to 25° C. The curable composition was continuously discharged over the entire surface of a 4-inch wafer, the mold was placed on the water under a He atmosphere, exposed to light through the mold using a mercury lamp at an irradiation energy of 300 mJ/cm², and the mold was released, to thereby obtain a pattern.

Geometry and defect of the thus obtained pattern were observed under a scanning electron microscope, and evaluated as follows. Results are shown in Table below.

### (Geometrical Evaluation)

OK: rectangular pattern exactly conforming to the mold; and
NG: at least either defect of rounded pattern top, or insufficient height of pattern.

### <Omission Defect of Pattern in Continuous Patterning>

Similarly to the technique of measuring the rectangularity in initial patterning, the pattern was repetitively transferred onto 20 wafers using the same mold, and the pattern obtained by the 20-th transfer was evaluated as follows. The transfer was also repeated 100 times, and the obtained pattern was evaluated as follows. Results are shown in Table below.

### (Evaluation of Defects)

Separation, omission, and collapse of the pattern were observed.

A: no pattern defect;
B: pattern defect found in a partial area smaller than 2% of the total pattern area;
C: pattern defect found in an area of 2% or larger, and smaller than 5% of the total pattern area;
D: pattern defect found in an area of 5% or larger, and smaller than 10% of the total pattern area; and
E: pattern defect found in an area of 10% or larger of the total pattern area.

TABLE 3

| | Viscosity of | | | |
|---|---|---|---|---|
| | curable | Temperature rise of 1:1 | | Omission defect of |
| | composition at | mixture of curable | Rectangularity in | pattern in repetitive patterning |
| | 25° C. (mPa · s) | composition + (C) [° C.] | initial patterning | (20th transfer/100th transfer) |
| Example 1 | 11 | 1 | OK | A/A |
| Example 2 | 11 | 1 | OK | A/B |
| Example 3 | 11 | 1 | OK | B/C |
| Example 4 | 11 | 1 | OK | A/A |
| Example 5 | 11 | 3 | OK | A/A |
| Example 6 | 11 | 2 | OK | C/C |
| Example 7 | 15 | 1 | OK | A/B |
| Example 8 | 13 | 1 | OK | A/A |
| Example 9 | 13 | 1 | OK | A/A |
| Example 10 | 13 | 3 | OK | B/B |
| Example 11 | 13 | 3 | OK | A/A |
| Example 12 | 18 | 1 | OK | A/A |
| Example 13 | 18 | 2 | OK | B/B |
| Example 14 | 20 | 1 | OK | B/C |
| Example 15 | 18 | 1 | OK | A/B |
| Example 16 | 18 | 1 | OK | A/A |
| Example 17 | 11 | 3 | OK | A/A |
| Example 18 | 11 | 2 | OK | B/C |
| Example 19 | 11 | 1 | OK | B/B |
| Example 20 | 11 | 6 | OK | C/C |
| Example 21 | 11 | 4 | OK | B/C |
| Comparative Example 1 | 11 | −2 | OK | D/E |
| Comparative Example 2 | 11 | −3 | OK | D/E |
| Comparative Example 3 | 13 | −3 | OK | E/E |
| Comparative Example 4 | 18 | — | NG | E/E |

TABLE 4

| | Viscosity of curable | Temperature rise of | | Omission defect of pattern |
|---|---|---|---|---|
| | composition at | 1:1 mixture of curable | Rectangularity in | in repetitive patterning |
| | 25° C. (mPa · s) | composition + (C) [° C.] | initial patterning | (20th transfer/100th |
| Example 22 | 11 | 1 | OK | B/B |
| Example 23 | 11 | 1 | OK | A/B |
| Example 24 | 11 | 1 | OK | A/B |
| Example 25 | 11 | 1 | OK | A/A |
| Example 26 | 11 | 1 | OK | A/B |
| Example 27 | 11 | 3 | OK | C/C |
| Example 28 | 13 | 2 | OK | A/B |
| Example 29 | 13 | 2 | OK | B/B |
| Example 30 | 13 | 2 | OK | A/A |
| Example 31 | 13 | 3 | OK | A/A |
| Example 32 | 13 | 3 | OK | A/A |
| Example 33 | 13 | 2 | OK | A/A |
| Example 34 | 13 | 2 | OK | A/B |
| Example 35 | 13 | 2 | OK | B/B |
| Example 36 | 13 | 2 | OK | A/A |
| Example 37 | 9 | 3 | OK | A/A |
| Example 38 | 8 | 3 | OK | B/B |
| Example 39 | 10 | 2 | OK | B/B |
| Example 40 | 9 | 3 | OK | A/A |
| Example 41 | 9 | 3 | OK | A/A |
| Example 42 | 8 | 2 | OK | B/C |
| Comparative | 13 | −2 | OK | D/D |
| Example 5 | | | | |
| Comparative | 14 | −3 | OK | D/E |
| Example 6 | | | | |
| Comparative | 8 | — | NG | E/E |
| Example 7 | | | | |

### <Atmosphere Dependence of Mold Placement>

The rectangularity of initial patterning and the omission defect of pattern in continuous patterning were evaluated similarly as described in the above, except that the mold was placed on the wafer under a reduced pressure of 0.1 atm. Results are shown in Table below.

TABLE 5

| | Viscosity of | | | |
|---|---|---|---|---|
| | curable | Temperature rise of | Rectangularity | Omission defect of pattern in |
| | composition at | 1:1 mixture of curable | in initial | repetitive patterning |
| | 25° C. (mPa · s) | composition + (C) [° C.] | patterning | (20th transfer/100th transfer) |
| Example 1 | 11 | 1 | OK | A/B |
| Example 2 | 11 | 1 | OK | B/B |
| Example 3 | 11 | 1 | OK | C/C |
| Example 4 | 11 | 1 | OK | A/B |
| Example 5 | 11 | 3 | OK | B/B |
| Example 6 | 11 | 2 | OK | C/D |
| Example 7 | 15 | 1 | OK | B/B |
| Example 8 | 13 | 1 | OK | A/B |
| Example 9 | 13 | 1 | OK | A/B |
| Example 10 | 13 | 3 | OK | B/C |
| Example 11 | 13 | 3 | OK | A/B |
| Example 12 | 18 | 1 | OK | A/B |
| Example 13 | 18 | 2 | OK | B/C |
| Example 14 | 20 | 1 | OK | C/C |
| Example 15 | 18 | 1 | OK | B/B |
| Example 16 | 18 | 1 | OK | A/B |
| Example 17 | 11 | 3 | OK | A/B |
| Example 18 | 11 | 2 | OK | C/C |
| Example 19 | 11 | 1 | OK | B/C |
| Example 20 | 11 | 6 | OK | C/D |
| Example 21 | 11 | 4 | OK | C/C |
| Comparative | 11 | −2 | OK | E/E |
| Example 1 | | | | |
| Comparative | 11 | −3 | OK | E/E |
| Example 2 | | | | |
| Comparative | 13 | −3 | NG | E/E |
| Example 3 | | | | |
| Comparative | 18 | — | NG | E/E |
| Example 4 | | | | |

TABLE 6

| | Viscosity of | | | |
|---|---|---|---|---|
| | curable | Temperature rise of 1:1 | | Omission defect of pattern in |
| | composition at | mixture of curable | Rectangularity in | repetitive patterning |
| | 25° C. (mPa · s) | composition + (C) [° C.] | initial patterning | (20th transfer/100th transfer) |
| Example 22 | 11 | 1 | OK | B/C |
| Example 23 | 11 | 1 | OK | A/B |
| Example 24 | 11 | 1 | OK | A/B |
| Example 25 | 11 | 1 | OK | A/A |
| Example 26 | 11 | 1 | OK | B/B |
| Example 27 | 11 | 3 | OK | C/C |
| Example 28 | 13 | 2 | OK | A/B |
| Example 29 | 13 | 2 | OK | B/C |
| Example 30 | 13 | 2 | OK | A/B |
| Example 31 | 13 | 3 | OK | A/A |
| Example 32 | 13 | 3 | OK | A/B |
| Example 33 | 13 | 2 | OK | A/A |
| Example 34 | 13 | 2 | OK | A/B |
| Example 35 | 13 | 2 | OK | B/C |
| Example 36 | 13 | 2 | OK | A/A |
| Example 37 | 9 | 3 | OK | A/B |
| Example 38 | 8 | 3 | OK | B/C |
| Example 39 | 10 | 2 | OK | B/B |
| Example 40 | 9 | 3 | OK | A/C |
| Example 41 | 9 | 3 | OK | A/A |
| Example 42 | 8 | 2 | OK | C/C |
| Comparative | 13 | −2 | OK | E/E |
| Example 5 | | | | |
| Comparative | 14 | −3 | NG | E/E |
| Example 6 | | | | |
| Comparative | 8 | — | NG | E/E |
| Example 7 | | | | |

As is clear from Tables in the above, the compositions of the present invention were found to be excellent in the rectangularity of pattern, and was able to effectively suppress pattern defects even after repetitive formation of pattern.

The present disclosure relates to the subject matter contained in Japanese Patent Application No. 183954/2011 filed on Aug. 25, 2011, and Japanese Patent Application No. 167695/2012 filed on Jul. 27, 2012, which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A curable composition for imprints comprising a polymerizable compound (A), a photo-polymerization initiator (B) and a non-polymerizable compound (C); the non-polymerizable compound (C) dissolving into the curable composition for imprints in an exothermic manner.

2. The curable composition for imprints according to claim 1, wherein the non-polymerizable compound (C) has a molecular weight of 500 or larger.

3. The curable composition for imprints according to claim 1, wherein the non-polymerizable compound (C) stays in liquid at 25° C.

4. The curable composition for imprints according to claim 1, wherein the non-polymerizable compound (C) has a vapor pressure at 25° C. of 100 Pa or smaller.

5. The curable composition for imprints according to claim 1, having a viscosity at 25° C. of smaller than 20 mPa·s.

6. The curable composition for imprints according to claim 1, wherein the polymerizable compound (A) is a (meth)acrylate compound.

7. The curable composition for imprints according to claim 1, wherein the polymerizable compound (A) has an aromatic group and/or alicyclic hydrocarbon group.

8. The curable composition for imprints according to claim 1, wherein the polymerizable compound (A) contains a compound having a fluorine atom and/or silicon atom.

9. The curable composition for imprints according to claim 1, wherein two or more species of the photo-polymerization initiator (B) are used in a combined manner.

10. The curable composition for imprints according to claim 1, wherein the non-polymerizable compound (C) has a molecular weight of 500 or larger, and the non-polymerizable compound (C) stays in liquid at 25° C.

11. The curable composition for imprints according to claim 1, wherein the non-polymerizable compound (C) has a molecular weight of 500 or larger, and the non-polymerizable compound (C) has a vapor pressure at 25° C. of 100 Pa or smaller.

12. The curable composition for imprints according to claim 1, wherein the non-polymerizable compound (C) stays in liquid at 25° C., and which has a viscosity at 25° C. of smaller than 20 mPa·s.

13. The curable composition for imprints according to claim 1, wherein the non-polymerizable compound (C) has a molecular weight of 500 or larger, the non-polymerizable compound (C) stays in liquid at 25° C., and the non-polymerizable compound (C) has a vapor pressure at 25° C. of 100 Pa or smaller, and which has a viscosity at 25° C. of smaller than 20 mPa·s.

14. A method of producing the curable composition for imprints described in claim 1, the curable composition for imprints comprising the polymerizable compound (A), the photo-polymerization initiator (B) and the non-polymerizable compound (C), and the non-polymerizable compound (C) dissolving into the curable composition for imprints in an exothermic manner, the method comprising stirring the curable composition for imprints.

15. A method of forming a pattern, comprising:
applying the curable composition for imprints described in claim 1 on a base, or on a mold having a fine pattern formed thereon; and exposing the curable composition for imprints to light, while holding it between the mold and the base.

16. The method of forming a patterning according to claim 15,
wherein the mold is brought into contact with a fresh curable composition for imprints, while retaining thereon the non-polymerizable compound (C).

17. The method of forming a patterning according to claim 15,
wherein the curable composition for imprints is applied to the base or the mold by an ink jet process.

18. A pattern obtained by the method described in claim 15.

19. An electronic device containing the pattern described in claim 18.

20. A method of manufacturing an electronic device, comprising the method of forming a pattern described in claim 15.
